(19) United States
(12) Patent Application Publication
(10) Pub. No.: US 2025/0159503 A1
(43) Pub. Date: May 15, 2025

(54) PCI COLLISION AVOIDANCE IN 5G MOBILE IAB

(71) Applicant: CANON KABUSHIKI KAISHA, Tokyo (JP)

(72) Inventors: Pierre VISA, RENNES (FR); Pascal LAGRANGE, La Chapelle des Fougeretz (FR)

(21) Appl. No.: 18/996,310

(22) PCT Filed: Jun. 28, 2023
(86) PCT No.: PCT/EP2023/067743

§ 371 Date: Jan. 17, 2025

(30) Foreign Application Priority Data
Jul. 21, 2022 (GB) 2210690.0
Sep. 29, 2022 (GB) 2214304.4

(51) Int. Cl. H04W 24/02; H04W 8/26; H04W 84/04

(52) U.S. Cl. CPC H04W 24/02; H04W 8/26; H04W 84/047

(57) ABSTRACT

A Physical Cell Identity, PCI, conflict avoidance method in a wireless network comprising a first base station controlling a first cell having a first PCI, the method comprising: determining a conflict between the first PCI and a PCI of another cell in the vicinity of the first cell; and activating a second cell having a second PCI, wherein the second PCI is different to the first PCI.

### FIELD OF THE INVENTION

The present invention generally relates to methods for use in a process for mitigating signals interference involving Integrated Access and Backhaul, IAB, nodes.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems-based IEEE 802.11 standards, such as WiFi.

The demand for network densification increases due to the rising number of users and higher throughput requirement.

Facing the issues of high deployment costs and time of the wired backhaul networks with network densification, 3GPP has proposed, in recent release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications (between base stations) may use the same radio resources as access communications (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mm Wave) band to achieve the required Gbps (gigabits per second) data rate. However, millimeter waves are known to be subject to strong attenuations of signal strength in some weather conditions (rain, fog), and to blockage in case of obstacles located in the path between the emitter and the receiver.

Based upon the fixed IAB foundations laid off in releases 16 and 17, 3GPP is now considering Mobile IAB systems and architecture, as a part of the release 18 framework, in order to address scenarios focusing on mobile IAB-nodes mounted on vehicles. In such scenarios, mobile IAB-nodes can be referred to as Vehicle Mounted Relays (VMR), providing 5G coverage/capacity to on-board and/or surrounding UEs.

The technical benefits of using vehicle relays include, among others, the ability of the relay vehicle to get better macro coverage than the nearby UE, thanks to better RF/antenna capabilities, thus providing the UE with a better link to the macro network. Additionally, a vehicle relay is expected to have less stringent power/battery constraints than the UEs.

Urban environments are usually characterised by a high density of users along with the presence of a significant number of vehicles (e.g. public/private passengers transportation, goods delivery, food trucks . . . ). The speed of some of the vehicles may be pretty low or at least similar to pedestrian speed and some of these vehicles may even be temporarily stationary. Some of these vehicles (e.g. buses, trains or trams), may have predictable routes and/or limited mobility areas (e.g. some vehicles, such as food trucks or promotional vehicles, may be located outside stadiums or show venues) while others may have predictable stationary locations (e.g. taxis).

3GPP is considering that such vehicles could offer an opportunity to increase network coverage and connectivity to the UEs inside the vehicles, or even to UEs in proximity to the vehicles, by installing on these vehicles on-board base stations (or base station elements) that would act as relays. These relays would rely on 5G wireless backhaul (typically IAB, or Integrated Access & Backhaul) for connecting to a fixed donor device. Thus, based upon the fixed IAB foundations set out in Release 16 and 17, 3GPP is now considering Mobile IAB systems and architecture, as a part of the Release 18 framework, in order to address scenarios focusing on mobile IAB-nodes mounted on vehicles (for example, a bus, a train, a taxi). In such scenarios, mobile IAB-nodes can also be referred to as Vehicle Mounted Relays (VMR), providing 5G coverage/capacity to on-board and/or surrounding UEs. The technical benefits of using vehicle relays include, among others, the ability of the relay vehicle to get better coverage than the nearby UE, thanks to better RF/antenna capabilities, thus providing the UE with a better link to the macro network. Additionally, a vehicle relay is expected to have less stringent power/battery constraints than the UEs.

As a legacy base station, a mobile IAB-node manages one or several cell(s) in which UEs may camp and may connect to the network. Usually, a UE is configured to regularly perform measurements on cells in the neighborhood. Those measurements are performed at the initialization of the UE to search for candidate cells for the first connection to the network, but also when the UE is connected or in idle/inactive state to search for a cell with a better connection quality. Once a candidate cell has been found, the UE measures one or more parameters of signals received from the candidate cell. The parameters may include the reference signal received power (RSRP), or reference signal received quality (RSRQ). Typically, the UE measures RSRP or RSRQ on the Signal Synchronization Block (SSB). Further, the UE derives from the SSB the necessary information required to access the cell. In particular, the UE obtains the Physical Cell Identity (PCI) of the cell, which can be retrieved from the SSB. The SSB contains two synchronization signals: the PSS (Primary Synchronization Signal) and the SSS (Secondary Synchronization Signal). The PSS contains the physical layer identity (integer from 0 to 2) and the SSS contains the group number (integer from 0 to 335). The PCI value is obtained through a combination of these two values (physical layer identity+3×group number) providing an integer from 0 to 1007. Thus, the PCI value is not a unique identifier because of this limited range.

In PCI planning, neighbouring, or adjacent, cells cannot be allocated the same PCI. Indeed, PCI collision with neighbouring cells having the same PCI may introduce a synchronization delay for a UF performing cell search in an overlapping area of the cells. Additionally, it may lead to a high error rate and/or decoding failure of physical channels scrambled using the PCI, and may also generate some handover failure. As a consequence, PCI planning algorithms aim to avoid PCI collision by maximizing the PCI re-use distance, i.e. the physical separation between two cells having the same PCI value.

Furthermore, PCI confusion at the UE may also arise in the following cases:
If two neighboring cells have the same PCI Modulo 3 result, the same PSS are used by the cells with the consequence of UE synchronization delay,
If two neighboring cells have the same PCI Modulo 4 result, it may introduce interference with a Demodulation Reference Signal (DMRS),
If two neighboring cells have the same PCI Modulo 30 result, it may introduce inter-cell uplink interference.

In case of a mobile base station, like a mobile IAB-node or Vehicle Mounted Relay (VMR), the risk of PCI collision and confusion is high compared to a topology formed of stationary base stations, and even with a high quality PCI planning algorithm it may nevertheless prove difficult, or even impossible, to avoid PCI collision when the mobile base station moves in a large area. Therefore, there is a need to be able to change the PCI value of one or several cell(s) controlled by a mobile base station, while the mobile base station is serving UEs. Additionally, it would be beneficial to avoid service interruption at the UEs served by a mobile base station when the PCI value of a serving cell is changed.

The present invention aims to address some of the above identified issues with wireless communication systems incorporating mobile base stations.

### SUMMARY

In accordance with a first aspect of the invention there is provided a Physical Cell Identity, PCI, conflict avoidance method in a wireless network comprising a first base station controlling a first cell having a first PCI, the method comprising:
determining a conflict between the first PCI and a PCI of another cell in the vicinity of the first cell; and
   activating (e.g. when a conflict between the first PCI and a PCI of another cell in the vicinity of the first cell is determined) a second cell having a second PCI, wherein the second PCI is different to (and therefore does not cause a conflict with) the first PCI (and the PCI of the another cell).

Optionally, the second cell is activated, by the first base station, while the first cell is still active (i.e. such that a first cell with a first PCI and a second cell with a second, different and non-conflicting PCI, are simultaneously activated). Optionally, the step of determining a conflict between the first PCI and the PCI of another cell in the vicinity of the first cell is performed by the first base station. In one example, a cell in the vicinity of a first cell may correspond to a cell adjacent to the first cell, and which covers a geographical area that may partly or completely overlap with the geographical area covered by the first cell. In another example, a cell in the vicinity of a first cell may correspond to a cell not adjacent to the first cell but adjacent to a third cell that is also adjacent to the first cell. Optionally, the step of determining a conflict between the first PCI and the PCI of another cell in the vicinity of the first cell is performed by a second base station of the wireless network. Optionally, the step of determining a conflict between the first PCI and the PCI of another cell in the vicinity of the first cell is performed by a core network controlling the wireless network.

Optionally, the method further comprises the step of determining a value of the second PCI. Optionally, the step of determining a value of the second PCI is performed by the first base station. Optionally, the step of determining a value of the second PCI is performed by a second base station of the wireless network. The step of determining a value of the second PCI may be performed by a Central Unit, CU, of the first and/or second base station.

Optionally, the step of determining a value of the second PCI is performed by a core network controlling the wireless network.

Optionally, the step of activating the second cell is performed by a Distributed Unit, DU, of the first base station controlling the first cell. Optionally, the step of activating the second cell is performed in response to a request of a Central Unit, CU, of the first base station.

Optionally, the first cell is controlled by a first DU of the first base station, and the step of activating the second cell is performed by a second DU of the first base station. Optionally, the step of activating the second cell is performed in response to a request of the CU of the first base station.

Optionally, the first cell is controlled by a Distributed Unit, DU, of the first base station, and the step of activating the second cell is performed by a DU of a second base station. Optionally, the step of activating the second cell is performed in response to a request of a CU of the second base station.

In some examples, wherein the wireless network serves a user equipment initially connected to the first base station via a radio link in the first cell, the method may further comprise the step of following activation of the second cell, connecting the user equipment to the first base station via a radio link in the second cell.

In some examples, wherein the wireless network serves a user equipment initially connected to the first base station via a radio link in the first cell, the method may further comprise the step of:
following activation of the second cell,
connecting the user equipment to a second base station via a radio link in the second cell.

The first and/or or second distributed unit may be a logical distributed unit entity.

Optionally, the first and second distributed units are both logical distributed unit entities sharing the same physical layer. Optionally, the first and second distributed units are both logical distributed unit entities having separated physical layers.

Optionally, the first base station is a Next Generation Radio Access Network node.

Optionally, the first base station is a CU of an Integrated Access and Backhaul, IAB, donor node.

Optionally, the first base station is a CU of an Integrated Access and Backhaul, IAB, donor, and the, or each, DU is the DU of an IAB node of the IAB topology controlled by the donor CU. The IAB node may be a mobile IAB-node.

Optionally, the method further comprises the step of deactivating the first cell.

Optionally, the method further comprises the step of deactivating the first DU.

In accordance with a second aspect of the invention there is provided a base station configured to perform a method according to the first aspect.

In accordance with a third aspect of the invention there is provided method for a Central Unit, CU, of an Integrated Access and Backhaul, IAB, donor node, the CU of the IAB donor node controlling an IAB topology comprising a first cell established by a first Distributed Unit, DU, of an IAB node of the IAB topology, the method comprising:
determining a conflict between a Physical Cell Identity, PCI, of the first cell and a PCI of another cell in the vicinity of the first cell;
obtaining (e.g. when a conflict between the first PCI and a PCI of another cell in the vicinity of the first cell is determined) a new PCI that does not cause a conflict with the PCI of another cell in the vicinity of the first cell (or the PCI of the first cell itself); and
instructing the IAB node to activate, by the first DU of the IAB node, a second cell having the new PCI.

Optionally, the second cell is activated while the first cell is still active (i.e. such that a first cell with a first PCI and a second cell with a second, different and non-conflicting PCI, are simultaneously activated). In some examples, wherein user equipment is initially connected to the IAB donor node via a radio link in the first cell, the method may further comprise the step of:
triggering intra-DU handover of the user equipment from the first cell to the second cell.

Optionally, the method further comprises the step of:
instructing the IAB node to deactivate, by the first DU of the IAB node, the first cell.

In accordance with a fourth aspect of the invention there is provided method for a Central Unit, CU, of an Integrated Access and Backhaul, IAB, donor node, the CU of the IAB donor node controlling an IAB topology comprising a first cell established by a first Distributed Unit, DU, of an IAB node of the IAB topology, the method comprising:
determining a conflict between a Physical Cell Identity, PCI, of the first cell and a PCI of another cell in the vicinity of the first cell;
obtaining (e.g. when a conflict between the first PCI and a PCI of another cell in the vicinity of the first cell is determined) a new PCI that does not cause a conflict with the PCI of another cell in the vicinity of the first cell (or the PCI of the first cell itself); and
instructing the IAB node to activate, by a second DU of the IAB node, a second cell having the new PCI.

Optionally, the second cell is activated while the first cell is still active (i.e. such that a first cell with a first PCI and a second cell with a second, different and non-conflicting PCI, are simultaneously activated). In some examples, wherein a user equipment is initially connected to the IAB donor node via a radio link in the first cell, the method may further comprise the step of:
triggering inter-DU handover of the user equipment from the first cell to the second cell.

Optionally, the method further comprises the step of:
instructing the IAB node to deactivate, by the first DU of the IAB node, the first cell.

Optionally, the method further comprises the step of:
instructing the IAB node to deactivate the first DU.

In accordance with a fifth aspect of the invention there is provided method for a Central Unit, CU, of an Integrated Access and Backhaul, IAB, donor node, the CU of the target IAB donor node controlling a target IAB topology, the method comprising:
receiving, from a CU of a source IAB donor node controlling a source IAB topology, a node migration request for migrating an IAB node of the source IAB topology, the IAB node including a first Distributed Unit, DU, having established a first cell having a first Physical Cell Identity, PCI;
obtaining, by the CU of the target IAB donor node, a new PCI that does not cause a conflict with the PCI of another cell in the vicinity of the first cell (or the PCI of the first cell itself); and
instructing, by the CU of the target IAB donor node, a second DU of the migrating IAB node of the source IAB topology to establish a second cell having the new PCI.

Optionally, the second cell is activated while the first cell is still active (i.e. such that a first cell with a first PCI and a second cell with a second, different and non-conflicting PCI, are simultaneously activated). Optionally, the method further comprises the step of:
instructing the IAB node to deactivate, by the first DU of the IAB node, the first cell.

Optionally, the method further comprising the step of:
instructing the IAB node to deactivate the first DU.

In accordance with a sixth aspect of the invention there is provided base station configured to perform a Physical Cell Identity, PCI, conflict avoidance method in a wireless network comprising the base station controlling a first cell having a first PCI, the base station comprising:
means for determining a conflict between the first PCI and a PCI of another cell in the vicinity of the first cell; and
means for activating (e.g. when a conflict between the first PCI and a PCI of another cell in the vicinity of the first cell is determined) a second cell having a second PCI, wherein the second PCI is different to the first PCI (and the PCI of the another cell in the vicinity of the first cell). Optionally, the second cell is activated while the first cell is still active (i.e. such that a first cell with a first PCI and a second cell with a second, different and non-conflicting PCI, are simultaneously activated).

In accordance with a seventh aspect of the invention there is provided an Integrated Access and Backhaul, IAB, donor node comprising a Central Unit, CU, configured to control an IAB topology comprising a first cell established by a first Distributed Unit, DU, of an IAB node of the IAB topology, the IAB donor node comprising:
means for determining a conflict between a Physical Cell Identity, PCI, of the first cell and a PCI of another cell in the vicinity of the first cell;
means for obtaining (e.g. when a conflict between the first PCI and a PCI of another cell in the vicinity of the first cell is determined) a new PCI that does not cause a conflict with the PCI of another cell in the vicinity of the first cell (or the PCI of the first cell itself); and
means for instructing the IAB node to activate, by the first DU of the IAB node, a second cell having the new PCI.

Optionally, the second cell is activated while the first cell is still active (i.e. such that a first cell with a first PCI and a second cell with a second, different and non-conflicting PCI, are simultaneously activated). In some examples, wherein a user equipment is initially connected to the IAB donor node via a radio link in the first cell, the IAB donor node may further comprise:
means for triggering intra-DU handover of the user equipment from the first cell to the second cell.

Optionally, the IAB donor node further comprises:
means for deactivating the first cell.

In accordance with an eighth aspect of the invention there is provided an Integrated Access and Backhaul, IAB, donor node comprising a Central Unit, CU, configured to control an IAB topology comprising a first cell established by a first Distributed Unit, DU, of an IAB node of the IAB topology, the IAB donor node comprising:
means for determining a conflict between a Physical Cell Identity, PCI, of the first cell and a PCI of another cell in the vicinity of the first cell;
means for obtaining (e.g. when a conflict between the first PCI and a PCI of another cell in the vicinity of the first cell is determined) a new PCI that does not cause a conflict with the PCI of another cell in the vicinity of the first cell (or the PCI of the first cell itself); and
means for instructing the IAB node to activate, by a second DU of the IAB node, a second cell having the new PCI.

Optionally, the second cell is activated while the first cell is still active (i.e. such that a first cell with a first PCI and a second cell with a second, different and non-conflicting PCI, are simultaneously activated). In some examples, wherein user equipment is initially connected to the IAB donor node via a radio link in the first cell, the IAB donor node may further comprise:
means for triggering inter-DU handover of the user equipment from the first cell to the second cell.

Optionally, the IAB donor node further comprises:
means for deactivating the first cell.

Optionally, the IAB donor node further comprises:
means for deactivating the first DU.

In accordance with a ninth aspect of the invention there is provided Integrated Access and Backhaul, IAB, donor node comprising a target donor CU controlling a target IAB topology, the IAB donor node comprising:
means for receiving, from a source donor CU of a source IAB donor node controlling a source IAB topology, a node migration request for migrating an IAB node of the source IAB topology, the IAB node including a first Distributed Unit, DU, having established a first cell having a first Physical Cell Identity, PCI;
means for obtaining (e.g. when a conflict between the first PCI and a PCI of another cell in the vicinity of the first cell is determined) a new PCI that does not cause a conflict with the PCI of another cell in the vicinity of the first cell (or the PCI of the first cell itself); and
means for instructing a second DU of the migrating IAB node of the source IAB topology to establish a second cell having the new PCI.

Optionally, the second cell is activated while the first cell is still active (i.e. such that a first cell with a first PCI and a second cell with a second, different and non-conflicting PCI, are simultaneously activated). Optionally, the IAB donor node further comprises:
means for instructing the IAB node to deactivate the first cell.

Optionally, the IAB donor node further comprises:
means for instructing the IAB node to deactivate the first DU.

In accordance with a tenth aspect of the invention there is provided computer program comprising instructions which, when the program is executed by a computer, cause the computer to carry out the method according to the first to fifth aspects.

In accordance with an eleventh aspect of the invention there is provided a computer-readable medium carrying a computer program according to the tenth aspect.

The methods, apparatuses, computer programs and computer-readable mediums according to each of the above aspects may be considered to relate to methods of (and apparatuses for) dynamic PCI change, in the sense that the method can be performed continuously such that a new cell with a new PCI is activated in response to another cell entering the vicinity of an initial cell (the initial cell and the cell entering the vicinity being determined to have conflicting PCIs). Further, the methods, apparatuses, computer programs and computer-readable mediums according to each of the above aspects may be considered to relate to methods of (and apparatuses for) smooth PCI change, in the sense that a UE being served by the initial cell experiences no service interruption during the method.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by a processing unit, cause the processing unit to carry out the method of any aspect or example described above and a computer readable storage medium carrying the computer program.

It should also be appreciated that particular combinations of the various features described and defined in any aspects of the invention can be implemented and/or supplied and/or used independently.

### BRIEF DESCRIPTION OF THE DRAWINGS

Different aspects of the invention will now be described, by way of example only, and with reference to the following drawings in which:

FIG. 1 is a schematic diagram illustrates an exemplary communication system in which the present invention may be implemented according to one or more embodiments;

FIGS. 2a and 2b schematically illustrate stacks of some protocol layers involved into IAB operations;

FIG. 3 is a schematic diagram illustrating the format of a BAP Protocol Data Unit (PDU) or packet;

FIG. 4 is a schematic diagram illustrating an example of an IAB communication system (or IAB network system) in which the present invention may be implemented according to one or more embodiments;

FIG. 5 is a schematic diagram illustrating another example of an IAB communication system (or IAB network system) in which the present invention may be implemented according to one or more embodiments;

FIG. 6 is a schematic diagram illustrating another example of an IAB communication system (or IAB network system) in which the present invention may be implemented according to one or more embodiments;

FIG. 7a is a schematic diagram illustrating an example of IAB-node architecture enabling a smooth intra-CU PCI change without service interruption for the UEs served by an IAB-node;

FIG. 7b is a schematic diagram illustrating an example of IAB-node architecture enabling a smooth intra-CU PCI change or a smooth inter-CU PCI change without service interruption for the UEs served by an IAB-node;

FIG. 8 is a flowchart of an example of steps to perform the intra-CU PCI change procedure, in order to change the PCI of one or several cells controlled by an IAB-node without service interruption for the served UEs;

FIG. 9 is a flowchart of an example of steps to perform the inter-CU PCI change procedure, in order to change the PCI of one or several cells controlled by an IAB-node without service interruption for the served UEs;

FIG. 10a is a schematic diagram illustrating an example of a base station or RAN node architecture enabling a smooth intra-CU PCI change without service interruption for the UEs served by the RAN node;

FIG. 10b is a schematic diagram illustrating another example of a base station or RAN node architecture enabling a smooth intra-CU PCI change, or inter-CU PCI change, without service interruption for the UEs served by the RAN node

FIG. 11a is a flowchart of an example method of the procedure to perform the activation of a logical DU and/or cell(s) according to an embodiment of the invention;

FIG. 11b is a flowchart of an example method of the procedure to setup a logical DU;

FIG. 11c is a flowchart of an example method of the procedure to remove a logical DU;

FIG. 12a is a flowchart of an example method of the procedure used by a RAN Node CU to report new usage of PCI value(s) to another RAN Node CU;

FIG. 12b is a flowchart of an example method of the procedure used by a RAN Node CU to report new usage of PCI value(s) to the core network;

FIG. 12c is a flowchart of an example method of the procedure used by the core network to indicate a list of PCI value(s) that can be used by a RAN Node CU;

FIG. 13 is a schematic diagram of a wireless communication device in accordance with one or more embodiments of the present invention;

FIG. 14 is a flowchart illustrating an example method for managing at a CU of base station the change of PCI in one or several cells according to one or more embodiments of the present invention;

FIG. 15 is a flowchart of another example method for managing at a CU of base station the change of PCI in one or several cells according to one or more embodiments of the present invention;

FIG. 16 is a flowchart of an example method for managing the migration of an IAB node including the change of PCI in one or several cells according to one or more embodiments of the invention.

### DETAILED DESCRIPTION

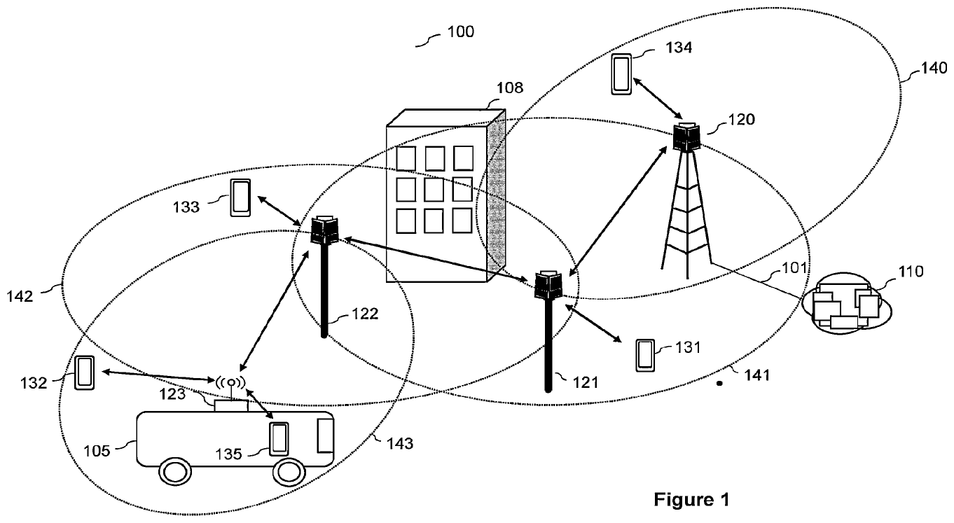

FIG. 1 illustrates an example communication system 100 in which the present invention may be implemented according to one or more embodiments.

As depicted, the system 100 is a wireless communication system, in particular a mobile radio communication system such as a fifth-generation (5G) New Radio (NR) system including a wireless Integrated Access and Backhaul network supporting mobile IAB-node. Although in the following description, embodiments and examples of embodiments of the present invention will be described with respect to a 5G NR system, it will be appreciated that it is not intended that the present invention is limited to 5G NR systems and may be used in any wireless communication systems having mobile base station.

The system 100 comprises a plurality of UEs (User Equipment) 132, 133, 131 and 134, a remote core network 110, a main Base Station 120, and two Integrated Access and Backhaul (IAB) stations or IAB nodes 121 and 122 (also referred to in the following as IAB-nodes), and a mobile Integrated Access and Backhaul (IAB) station 123 mounted on a vehicle 105

The main Base Station 120, also referred to as the IAB-donor 120, is connected to the core network 110 through a wired link 101, preferably an optical fiber or any other wired means. In embodiments and examples of embodiments of the invention, IAB-donor 120 is a 5G NR (referred to as a gNB) with additional functionality to support IAB features, as defined in 3GPP TS 38.300 V17.0.0 specification document.

In order to extend the network coverage of IAB-donor 120 and reach the remote UEs 132, 133 and 131, IAB stations 121 and 122, also referred to as IAB-nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 132 and 133 are operated at millimeter wave frequencies, which are highly sensitive to shadowing phenomena.

The IAB-donor 120 also serves UE 134, which is directly connected to it.

The mobile IAB station 123, also referred to as mobile IAB-node (or mIAB node 123), is an IAB-node that is mounted on vehicle 105, also provides network coverage and capacity extension, allowing the IAB-donor 120 to reach onboard remote UEs, like remote UE 135, as well as surrounding UEs or UEs in the vicinity of the IAB-node 123, like remote UE 136.

The IAB-donor 120 and the IAB-nodes 121 and 122 are thus forming a backhaul network or IAB network, or IAB topology, which accommodates UEs 132, 133, 131, 134, 135 and 136. The terms IAB network and IAB topology will be used interchangeably in the following.

The specification of the Integrated Access and Backhaul (IAB) is spread over several 3GPP standard documents, including:
TS 38.300 RAN architecture (V17.0.0),
TS 38.321 MAC protocol (V17.0.0),
TS 38.331 Radio Resource Control (RRC) protocol (V17.0.0),
TS 38.340 Backhaul Adaptation Protocol Layer (V17.0.0),
TS 38.401 RAN architecture (V17.0.0),
TS 38.473 F1 Application Protocol (V17.0.0).

As IAB-donor 120 and IAB-nodes 121, 122 and 123 are respectively connected to UEs 134, 131, 132, 133, 135 and 136, they are considered as Access IAB-nodes for their respectively connected UEs.

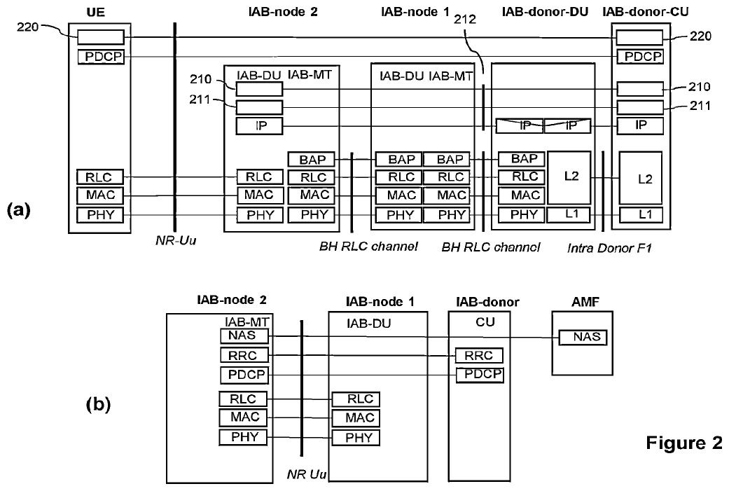

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or donor CU (also referred to in the following as IAB-donor CU) hosts higher layer protocols, such as PDCP (Packet Data Convergence Protocol) and RRC (Radio Resource Control) protocols, for controlling operation of one or more DUs and each of the one or more IAB-donor-DUs or donor DUs (also referred to in the following as IAB-donor DU) includes lower layer protocols, such as the RLC, MAC and physical layer protocols. The IAB-donor CU or donor CU and IAB-donor DU or donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality as shown in FIG. 2, discussed below.

The IAB nodes, which may serve multiple radio sectors, are wireless backhauled to the IAB-donor 120, via one or multiple hops over intermediate IAB nodes. They form a directed acyclic graph (DAG) topology with the IAB-donor at its root.

The IAB nodes consist of an IAB-DU and an IAB-MT (IAB-Mobile Termination). The gNB-DU functionality on an IAB-node is also referred to as IAB-DU and allows the downstream (toward the UE) connection to the next-hop IAB. The IAB-MT functionality includes, e.g., physical layer, layer-2, RRC and Non Access Stratum (NAS) functionalities to connect to the gNB-DU of an upstream IAB-node (including the IAB-donor 120 in which case it connects to the IAB-donor gNB-CU, hence to the core network 110, for instance for initialization, registration and configuration).

In this DAG topology, the neighbour node on the IAB-DU's interface is referred to as child node and the neighbour node on the IAB-MT's interface is referred to as parent node. The direction toward the child node is further referred to as downstream while the direction toward the parent node is referred to as upstream.

The IAB-donor 120 performs centralized resource, topology and route management for the whole IAB topology. This includes configuring the IAB-nodes according to the network topology, e.g. in order to perform appropriate routing of data packets.

In the example of the FIG. 1, the DU part of IAB-donor 120, IAB-nodes 121, 122, and mobile IAB-node 123 controls respectively the cells 140, 141, 142 and 143. The coverage of different cells creates some overlapping areas where a UE can detect the Signal Synchronization Block (SSB) from different DUs (being DU parts of IAB-nodes, IAB-donors, mobile IAB-nodes, or legacy base stations). The Physical Cell Identity (PCI) value conveyed in each SSB helps the UE to differentiate the cells. PCI planning algorithms aim to avoid PCI collision (i.e. re-use of the PCI same value for adjacent cells), and PCI confusion (i.e. PCI values of adjacent cells introducing interferences).

In cellular networks, the PCI values can be assigned either in a centralized or distributed way. When centralized assignment is used, the Operations Administration and Maintenance (OAM) system, which has a complete knowledge and control of the PCIs planning, will instruct a base station to use a dedicated PCI for each cell the base station controls. When the distributed solution is used, the OAM system assigns a list of possible PCIs to a base station, but the final choice of a PCI is done by the base station itself. The base station may request a report, sent either by UEs or by other base stations in the neighborhood, to know which PCIs are already used. Then, the base station will randomly select a PCI value from the remaining values in the list of possible PCIs provided by the OAM system.

It is the CU of a base station that sets the PCI for each of the DU(s) of the base station (a CU may control several DUs). Similarly, in an IAB topology, it is the IAB-donor CU that sets the PCI for each cell in the IAB topology it controls. The IAB-donor CU shall indicate to each donor-DU and to each DU of an IAB-node or mobile IAB-node, the PCI to use for the one or several cell(s) controlled by the DU.

FIGS. 2a and 2b schematically illustrate stacks of some protocol layers involved into IAB operations.

F1 interface supports the exchange of signalling information between the endpoints, as well as the data transmission to the respective endpoints. From a logical standpoint, F1 interface is a point-to-point interface between the endpoints.

In 5G NR, F1-C is the functional interface in the Control Plane (CP) between the IAB-donor-CU and an IAB-node-DU (e.g. of IAB-node 2), and between the IAB-donor-CU and an IAB-donor DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-node1 and then from IAB-node1 to IAB-node2).

In the User Plane, boxes 210 at the IAB-donor CU and the IAB-node DU refer to the GTP—U layer and boxes 211 refer to the UDP layer. GTP-U stands for GPRS Tunnelling Protocol User Plane. GTP-U Tunnels are used to carry encapsulated PDUs and signalling messages between a given pair of GTP-U Tunnel Endpoints (refer to 3GPP TS 29.281 for more details), here boxes 210 at the IAB-donor CU and the IAB-node DU. The well-known

User Datagram Protocol (UDP) is a transport layer protocol providing a best effort datagram service and fit to use with an IP protocol.

In the Control Plane, boxes 210 indicate the F1AP (F1 Application Protocol) layer and boxes 211 indicate the SCTP (Stream Control Transmission Protocol) layer. The F1 Application Protocol (as defined in 3GPP TS38.473 and TS 38.401) provides signalling services between the IAB-donor CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor CU and the IAB-node DU as defined in 3GPP TS 38.401.

The transport between the IAB-donor DU and the IAB-donor CU also uses an IP transport Layer over various media, like for example wires or optical fiber when the IAB-donor CU is remote from the IAB-donor DU, or locally in a virtual instantiation of the IAB-donor CU and the IAB-donor DU on the same physical machine. IAB-specific transport between IAB-donor-CU and IAB-donor-DU is specified in 3GPP TS 38.401.

L1 and L2 on the Figure stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

The IAB-DU's IP traffic is routed over the wireless backhaul via the BAP sublayer. In a downstream direction, upper layer packets are encapsulated by the BAP sublayer at the IAB-donor DU, thus forming BAP packets or packet data units (PDUs) or data packets. The BAP packets are routed by the BAP layer or entity (and corresponding BAP entities in the IAB-DU and IAB-MT) of the intermediate IAB-nodes, if any. The BAP packets are finally de-encapsulated by the BAP sublayer at the destination IAB-node (which may be an access IAB-node should the upper layer packets in the BAP packets be intended for a UE).

In an upstream direction, upper layer packets are encapsulated by the BAP sublayer at an initiator IAB-node (which may be an access IAB-node should the upper layer packets come from a UE), thus forming BAP packets or data units (PDUs) or data packets. The BAP packets are routed by the BAP layer (and corresponding BAP entities in the IAB-DU and IAB-MT) of the intermediate IAB-nodes, if any. The BAP packets are finally de-encapsulated by the BAP sublayer at the IAB-donor DU.

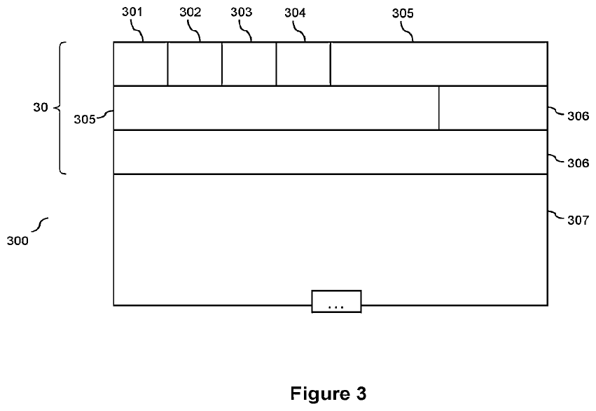

On the BAP sublayer, packets are routed based on the BAP routing ID, which is carried in the BAP header of the BAP packets, and which is set by the BAP sublayer of the emitting IAB-donor-DU or initiator IAB-node (e.g. a network node in the IAB network generating the BAP packets). FIG. 3 illustrates the format of a BAP Data Protocol Data Unit (PDU) or packet 300. It is specified in the standardized version paragraph 6.2 of 3GPP TS38.340 release 17.0.0.

A header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e. on the BAP sublayer) of the destination IAB-node or IAB-donor DU for the BAP packet. For the purpose of routing, each IAB-node and IAB-donor DU is configured (by an IAB-donor CU which controls the IAB network or topology to which the IAB-node and IAB-donor DU belong) with a designated BAP address. Field 306 carries a path ID identifying the routing path the BAP packet should follow to this destination in the IAB topology. The routing paths, including their path IDs, are configured in the same way the BAP address is configured.

The BAP header is added to the packet when it arrives from upper layers to the BAP layer, and it is stripped off by the BAP layer when it has reached its destination node. The selection of the packet's BAP routing ID is configured by the IAB-donor-CU.

For instance, when the BAP packet is generated by an IAB-node, i.e. either by the IAB-donor for downstream transmission or by an initiator IAB-node for upstream transmission (which may be an access IAB-node should the upper layer packets come from a UE), the BAP header with the BAP Routing ID is built by this IAB-node according to a configuration table defined in 3GPP TS 38.340. This table is called Downlink Traffic to Routing ID Mapping Configuration table in the IAB-donor or Uplink Traffic to Routing ID) Mapping Configuration table in the initiator IAB-node. In intermediate IAB-nodes, the BAP header fields are already specified in the BAP packet to forward.

As mentioned above, these configuration tables defining the BAP paths (hence the routing strategy and the configuration of the IAB-nodes given the IAB network topology) are usually defined by the IAB-donor-CU controlling the IAB network and transmitted to the IAB-nodes to configure them.

To process the transport of messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS38.322. The MAC (Media Access Channel) protocol sublayer is responsible for selecting available transmission formats for the user data and for the mapping of logical channel to the transport channels. The MAC also handles a part of the Hybrid Automated Repetition request scheme. The MAC layer is detailed in TS 38.321. On the emitter side or transmitter side, the MAC encapsulates the data packet issued from the RLC. It adds a header carrying information necessary to the MAC function. On the receiver side, the MAC decapsulates the data packet issued from the PHY, deletes its header and passes the remaining data to the RLC. The PHY sublayer provides an electrical interface to the transmission medium (the air) by converting the stream of information into physical modulation signals, modulating a carrier frequency at the emitter side. At the receiver side the PHY sublayer converts the physical modulation signals back to a stream of information. The PHY layer is described in TS 38.201, TS 38.211, TS 38.212, TS 38.213, TS 38.214.

To pass messages towards the user or control plane, two other sublayers are used in the UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The PDCP sublayer handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS38.323.

SDAP sublayer 220 for the User Plane handles the Quality of Service. It is described in TS38.324. On the UE side, the SDAP sublayer exchanges the payload data with the user's application (voice, video, etc., not shown in the Figure). On the IAB-donor side, the SDAP sublayer exchanges the data with the Core Network 110 (Internet traffic, Cloud, etc.).

RRC sublayer 220 for the Control Plane handles the configuration of the protocol entities of the User Plane protocol stack. It is described in TS38.331. It is responsible for the handling of, inter alia, broadcasting information necessary to a UF to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e. its access IAB-node (for both CP and UP).

FIG. 2b comes from 3GPP TS 38.300 V17.0.0 and illustrates the protocol stack for the support of IAB-MT's RRC and NAS connections. The Non-Access Stratum (NAS) protocol handles the messages between the core network and a user equipment, here an IAB-node. It manages the establishment of communication sessions and maintains communications with the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information for the IAB-node. AMF is only responsible for handling connection and mobility management tasks.

The IAB-MT establishes signalling Radio Bearers SRBs (bearers carrying RRC and NAS messages) with the IAB-donor-CU. These SRBs are transported between the IAB-MT and its parent node(s) over NR-Uu interface(s).

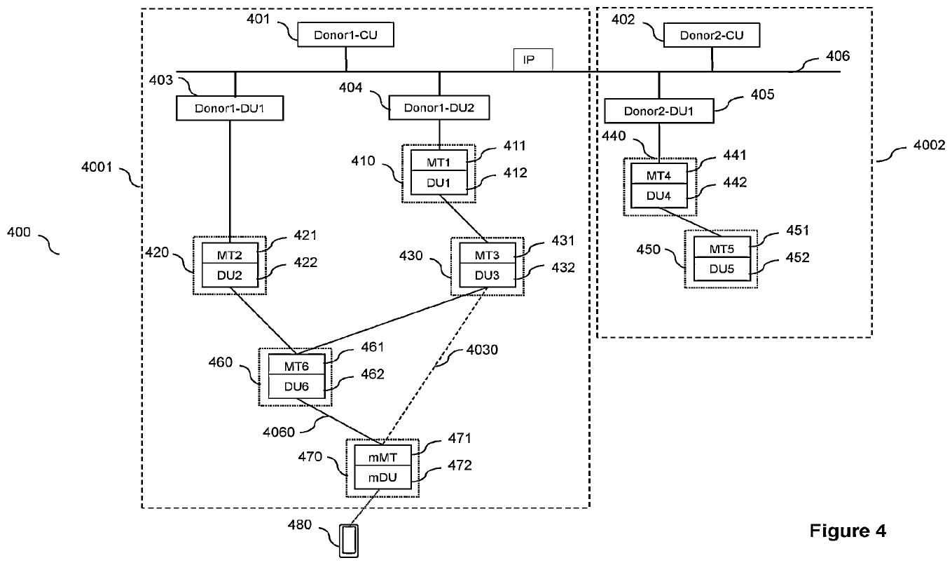

FIG. 4 illustrates an example of a wireless communication system (or IAB network) 400 in which embodiments and examples of embodiments of the present invention may be implemented. In one example implementation, the radio links between the IAB nodes and IAB donor DU nodes (referred to as BH radio links) are operated over the millimeter wave frequency band (i.e. above 30 GHz), which is highly sensitive to radio channel disturbance. An IAB network will also be referred to as an IAB topology or topology and so in this application, the terms IAB network and IAB topology and topology will be used interchangeably.

IAB communication system 400 is composed of two IAB networks or IAB topologies 4001 and 4002 with each IAB topology comprising a set of IAB nodes (e.g. the set may comprise a plurality of IAB nodes or at least one IAB node) and a IAB-donor CU for controlling or managing the plurality of IAB nodes. The set of IAB nodes may include one or more IAB-nodes, such as initiator IAB-nodes which generate BAP packets and also intermediate or relay IAB-nodes. The set of IAB nodes may also include one or more IAB donor DUs. Each of the IAB nodes communicate with at least one other IAB node over a wireless backhaul (BH) link.

Although FIG. 4 shows two IAB topologies 4001 and 4002, the present invention is not limited to two IAB topologies 4001 and 4002 and may be implemented in an IAB communication system comprising more than two IAB topologies with each topology comprising a set of IAB nodes and a IAB donor CU as discussed above.

IAB topology 4001 includes IAB-donor-CU 401 (identified as Donor1-CU in FIG. 4), its associated IAB-donor-DUs, IAB-donor-DU 403 (identified as Donor1-DU1 in FIG. 4) and IAB-donor-DU 404 (identified as Donor1-DU2 in FIG. 4), and a plurality of IAB-nodes 410, 420, 430, and 460, similar to IAB-nodes 121 and 122, and IAB-node 470, similar to mobile IAB-node 123. All IAB-nodes can be access nodes serving UEs like the UE 480 served by the mobile IAB-node 470. The IAB topology 4001 is transparent for the UE 480 that connects to the donor CU 401 through the DU part or unit mDU 472 of the mobile IAB-node 470.

IAB topology 4002 includes IAB-donor-CU 402 (identified as Donor2-CU in FIG. 4), and its associated IAB-donor-DU 405 (identified as Donor2-DU1 in FIG. 4), and a plurality of IAB-nodes 440 and 450, similar to IAB-nodes 121 and 122. The IAB network 400 can provide network path diversity through several IAB-donor-DUs and different IAB networks or topologies.

As discussed above, each IAB node comprises a Mobile Termination (MT) part or unit, controlled and configured by the IAB donor CU using RRC messaging as defined in 3GPP TS 38.331, and a Distributed Unit (DU) part, controlled and configured by the IAB donor CU using F1-AP messaging as defined in 3GPP TS 38.473. For example, IAB-node 410 comprises a MT part or unit 411 and a DU part or unit 412.

A wired backhaul IP network interconnects the IAB-donor-CUs 401 and 402, and the IAB-donor-DUs 403, 404 and 405 through wired link 406. For instance, this wired link consists of optical fiber cable(s).

IAB-Donor-CU 401, IAB-Donor-DUs 403 and 404, IAB-nodes 410, 420, 430, 460, 470 and IAB-node 470 are part of the same IAB network or IAB topology 4001, which is controlled (e.g. configured and/or managed) by IAB-Donor-CU 401.

IAB-Donor-CU 402, IAB-Donor-DU 405 and IAB-nodes 440 and 450 are part of the same IAB network or IAB topology 4002, which is configured and managed or controlled by IAB-Donor-CU 402.

All the donor DUs 403, 404, 405, and the DUs of IAB-nodes 412, 422, 462, 472, 442, 452, handle one or several cells not represented in the Figure.

In this example, the mobile IAB-node 470 is first single connected to the IAB-node 460 through the link 4060. Assuming the mobile IAB-node 470 is moving in the direction of IAB-node 430, the mobile IAB-node 470 may have the opportunity to be dual-connected with the IAB-node 430 as a second parent IAB-node through the link 4030. Instead of dual-connectivity, the mobile IAB-node 470 may be migrated to the IAB-node 430 by the donor CU 401, then the mobile IAB-node 470 will be single connected to the IAB-node 430 through the link 4030, and it will no longer be connected to the IAB-node 460.

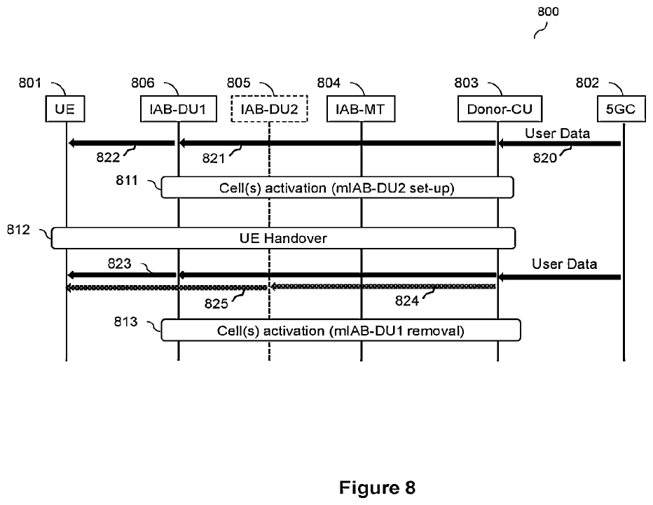

When moving in the direction of IAB-node 430 and also of IAB-node 410, a PCI used by the mobile IAB-node 470 for one of its cells may be in conflict with one or several PCI value(s) used in the IAB-node 410 (for instance). The donor CU 401 can detect this potential PCI collision based on the knowledge of the proximity of the mobile IAB-node 470 to the cell(s) controlled by IAB-node 410 (i.e. according to the new connection to the IAB-node 430). Therefore, the donor CU 401 may trigger the procedure for PCI change described with the FIG. 8 (intra-CU PCI change) according to an embodiment of the invention.

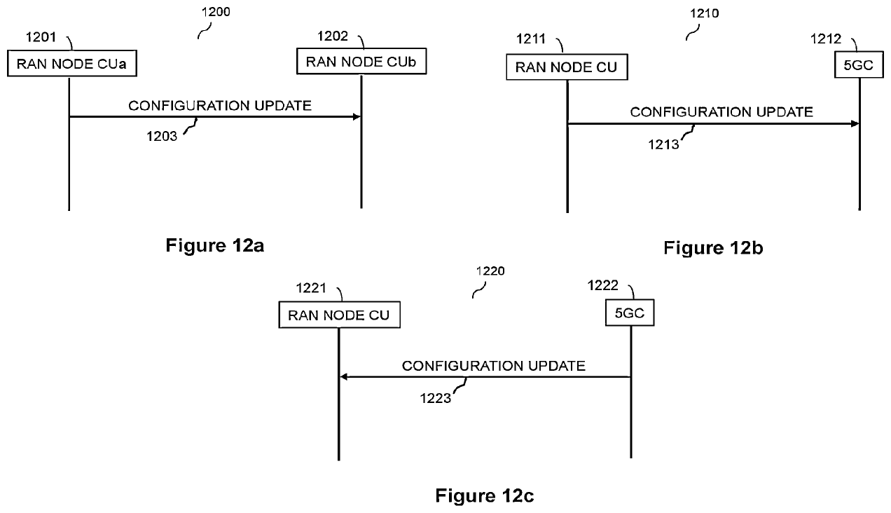

As an alternative for the detection of PCI collision, the donor CU 401 may send a notification to the core network (not represented in the Figure) of the new location of the cell(s) controlled by the mobile IAB-node 470, using the procedure described in the FIG. 12b. In return, the core network may indicate to the donor CU 401 the potential PCI collision and an update of the PCI value or of the list of PCI values that can be assigned to the cell(s) of the mobile IAB-node 470. The response of the core network can be performed with the procedure described with the FIG. 12c.

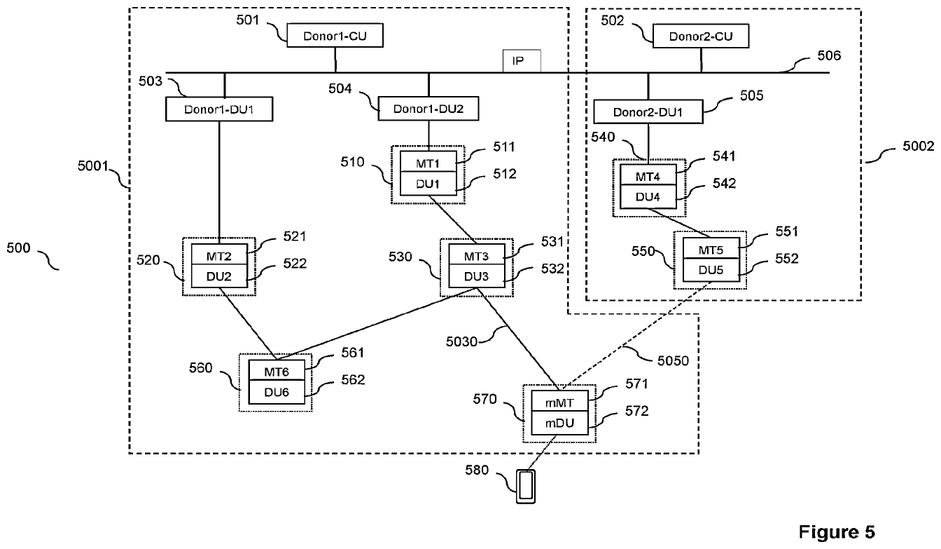

FIG. 5 illustrates another example of an IAB communication system (or IAB network system) 500 in which embodiments and examples of embodiments of the present invention may be implemented. It is similar to the system 400 described in the FIG. 4 with two IAB topologies 5001 and 5002. IAB topology 5001 includes IAB-donor-CU 501 (identified as Donor1-CU in FIG. 5), its associated IAB-donor-DUs, IAB-donor-DU 503 (identified as Donor1-DU1 in FIG. 5) and IAB-donor-DU 504 (identified as Donor1-DU2 in FIG. 5), and a plurality of IAB-nodes 510, 520, 530, and 560, similar to IAB-nodes 121 and 122. IAB topology 5002 includes IAB-donor-CU 502 (identified as Donor2-CU in FIG. 5), and its associated IAB-donor-DU 505 (identified as Donor2-DU1 in FIG. 5), and a plurality of IAB-nodes 540 and 550, similar to IAB-nodes 121 and 122, and IAB-node 570, similar to mobile IAB-node 123. The IAB topology 5002 is transparent for the UE 580 that connects to the donor CU 502 through the DU part or unit mDU 572 of the mobile IAB-node 570.

FIG. 5 illustrates the result of the migration of the IAB node 470 in FIG. 4 (i.e. the IAB-node 570 in FIG. 5), which is now connected to the IAB-node 430 (i.e. the IAB-node 530 in FIG. 5) through the link 5030, and it is no longer connected to the IAB-node 460 (i.e. the IAB-node 560 in FIG. 5).

While the mobile IAB-node is moving in the direction of IAB-topology 5002 and the IAB-node 550, several scenarios are possible according to the IAB framework.

As a first scenario, the topology redundancy procedure may be applied, as described in TS 38.401 V17.0.0 section 8.17.2.1, where a dual connectivity is established for the IAB-node 570 with two parent IAB-nodes 530 and 550 belonging to two different IAB topologies.

When the IAB-node 570 is initially connected to a single IAB topology (e.g. IAB topology 4001), the MT part or unit mMT 571 of IAB-node 570 periodically performs a cell search procedure, as defined in 3GPP TS 38.300, trying to detect a PSS (Primary Synchronization Signal) and a SSS (Secondary Synchronization Signal). The IAB-node may report to its donor CU 501 the presence of a new cell managed, for instance by the IAB-node 550, through a measurement report including the PCI of the cell as computed with PSS and PSS signals. Based on the analysis of the measurement report, the donor CU 501 may request to the donor CU 502 the establishment of a dual connectivity for the IAB-node 570 with an additional connection through the IAB-node 550. The donor CU 502 may accept the request and proceed to the connection of the IAB-node 570 according to the procedure described in TS 37.340 V17.0.0 section 10.2. As a result, the IAB-node 570, still belonging to IAB topology 5001, is now also connected to IAB-node 550, which belongs to IAB topology 5002, and it may be referred to as a boundary node between IAB topology 5001 and IAB topology 5002. Actually, the IAB-node 570 retains its F1 connection and its RRC connection to the donor CU 501, which can be referred to as the F1-terminating IAB-donor-CU, and the IAB-node 570 has another RRC connection to the donor CU 502, which can be referred to as the non-F1-terminating IAB-donor-CU.

As the IAB-node or boundary node 570 is part of the IAB topology 5001 (from the F1 connection point of view), it is controlled (e.g. configured and/or managed) by the IAB-Donor-CU 501 of IAB topology 5001.

When moving in the direction of IAB-node 550 and also of IAB-node 540, a PCI used by the mobile IAB-node 570 for one of its cells may be in conflict with the PCI value(s) used in the IAB-node 550 or 540 Assuming the donor CU 501 is informed about the PCI values set in the IAB topology 5002 (for instance with the procedure described in FIG. 12a), the donor CU 501 can detect the potential PCI collision following the new connection of the mobile IAB-node 570 in a cell controlled by the IAB-node 550. Therefore, the donor CU 501 may trigger the procedure for PCI change described with the FIG. 8 (intra-CU PCI change) according to embodiments of the invention.

As a second scenario in the FIG. 5, the BH link or BH radio link 5030 may also experience radio link deficiency due to some unexpected interference or shadowing phenomena. For such reasons, the IAB-node 570 may lose the connection with the IAB-node 530 and declare a Radio Link Failure (RLF) for the BH link 5030. Then, the IAB-node 570 will try to reestablish the connection with the same or a different parent IAB-node (or donor-DU). Thus, the IAB-node 570 may try to join the IAB topology 5002 managed by IAB-donor CU 502 with a connection through the new parent IAB-node 550 with the BH link 5050. In this case, the inter-CU backhaul RLF recovery procedure may be applied, as described in TS 38.401 V17.0.0 section 8.17.4, which enables recovery of an IAB-node to another parent node underneath a different IAB-donor-CU, when the IAB-MT of the IAB-node declares a backhaul RLF. In such procedure, the donor CU 502 sends to the donor CU 501 a request to retrieve the context of the IAB-node 570. Based on the response from the donor CU 501, the donor CU 502 may accept the connection of the IAB-node 570, which becomes a boundary node still belonging to the IAB topology 5001. In this case, the IAB-node 570 retains its F1 connection to the donor CU 501 which can be referred to as the F1-terminating IAB-donor-CU, and the IAB-node 570 has a RRC connection to the donor CU 502, which can be referred to as the non-F1-terminating IAB-donor-CU.

As a third scenario in the FIG. 5, the IAB-node 570, which is single connected to the parent IAB-node 530, may be partially migrated toward the IAB topology 5002, meaning its RRC connection is migrated from an old parent node to a new parent node, where the old and the new parent nodes are served by different IAB-donor-CUs. Indeed, based on the measurement report provided by the IAB-node 570, the donor CU 501 may detect that the IAB-node 570 would have a better connection through a cell managed by the IAB-node 550 belonging to the IAB topology 5002. Then, the donor CU 501 may trigger the IAB Inter-CU Topology Adaptation procedure described in TS 38.401 V17.0.0 section 8.17.3.1. In this procedure, the donor CU 501 sends a handover request for the IAB-node 570 along with information for the donor CU 502 to establish a RRC connection to the IAB-node 570. Based on this information, the donor CU 502 may accept the handover request and proceed to the admission of the IAB-node 570, which becomes a boundary node still belonging to the IAB topology 5001, with F1 connection to the donor CU 501 and RRC connection to the donor CU 502.

In this third scenario, the IAB topology 5001 may be referred to as the source IAB network or source IAB topology, and the topology 5002 may be referred to as the target IAB network or target IAB topology. Also, the donor CU 501 may be referred to as the source IAB-Donor-CU or source donor CU, and the donor CU 502 may be referred to as the target IAB-Donor-CU or target donor CU.

In the second and the third scenario, when moving in the direction of IAB-node 550 and also of IAB-node 540, a PCI used by the mobile IAB-node for one of its cells may be in conflict with the PCI value(s) used in the IAB-node 550 or 540. Assuming the donor CU 501 is informed about the PCI values set in the IAB topology 5002 (for instance with the procedure described in FIG. 12a), the donor CU 501 can detect the potential PCI collision following the new connection of the mobile IAB-node 570 in a cell controlled by the IAB-node 550. Therefore, the donor CU 501 may trigger the procedure for PCI change described with the FIG. 8 (intra-CU PCI change) according to embodiments of the invention.

For the detection of potential PCI collision in the three scenarios described above, the donor CU 501 may send a notification to the core network (not represented in the Figure) of the new location of the cell(s) controlled by the mobile IAB-node 570, using the procedure described in the FIG. 12b. In return, the core network may indicate to the donor CU 501 a potential PCI collision and an update of the PCI value or of the list of PCI values that can be assigned to the cell(s) of the mobile IAB-node 570. The response of the core network may be performed with the procedure described with the FIG. 12c.

In all the three scenarios described above, the UE 580 still connects to the donor-CU 501 through the DU part or unit mDU 572 of the mobile IAB-node 570. In case the IAB-node 570 has some child IAB-node(s), such child IAB-node still belongs to the IAB topology 5001, and it is still fully controlled (through F1 and RRC connections) by the donor CU 501.

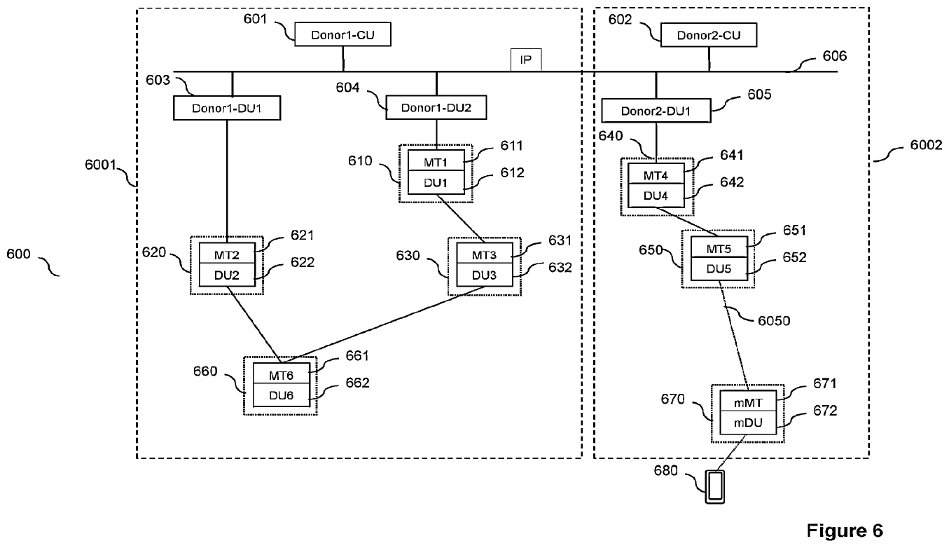

FIG. 6 illustrates another example of an IAB communication system (or IAB network system) 600 in which embodiments and examples of embodiments of the present invention may be implemented. It is similar to the system 500 described in the FIG. 5, with two IAB topologies 6001 and 6002. IAB topology 6001 includes IAB-donor-CU 601 (identified as Donor1-CU in FIG. 6), its associated IAB-donor-DUs, IAB-donor-DU 603 (identified as Donor1-DU1 in FIG. 6) and IAB-donor-DU 604 (identified as Donor1-DU2 in FIG. 6), and a plurality of IAB-nodes 610, 620, 630, and 660, similar to IAB-nodes 121 and 122. IAB topology 6002 includes IAB-donor-CU 602 (identified as Donor2-CU in FIG. 6), and its associated IAB-donor-DU 605 (identified as Donor2-DU1 in FIG. 6), and a plurality of IAB-nodes 640 and 650, similar to IAB-nodes 121 and 122, and IAB-node 670, similar to mobile IAB-node 123. The IAB topology 6002 is transparent for the UE 680 that connects to the donor CU 602 through the DU part or unit mDU 672 of the mobile IAB-node 670.

FIG. 6 illustrates the result of the full migration of the IAB node 570 in FIG. 5 (i.e. the IAB-node 670 in FIG. 6), which now fully belongs to the IAB topology 5002 in FIG. 5 (i.e. the IAB topology 6002 in FIG. 6).

Partial migration (described with reference to FIG. 5), allows for the IAB-MT part or unit mMT (571 in FIG. 5) to be migrated quickly to the target IAB-donor-CU (i.e. donor CU 502 in FIG. 5) and to be switched back quickly to the source IAB-donor-CU (i.e. donor CU 501 in FIG. 5). Thus, partial migration can be used advantageously when circumstances requiring inter-donor migration are only temporary, such as during traffic peak hours, or when transient RLF on a BH link is detected.

In the context of full migration, both the IAB-MT part or unit mMT 671 and the IAB-DU part or unit mDU 672 of IAB-node 670 are migrated to the target donor CU 602. The full migration is appropriate for a mobile IAB-node that moves and may cross several IAB topologies along its journey.

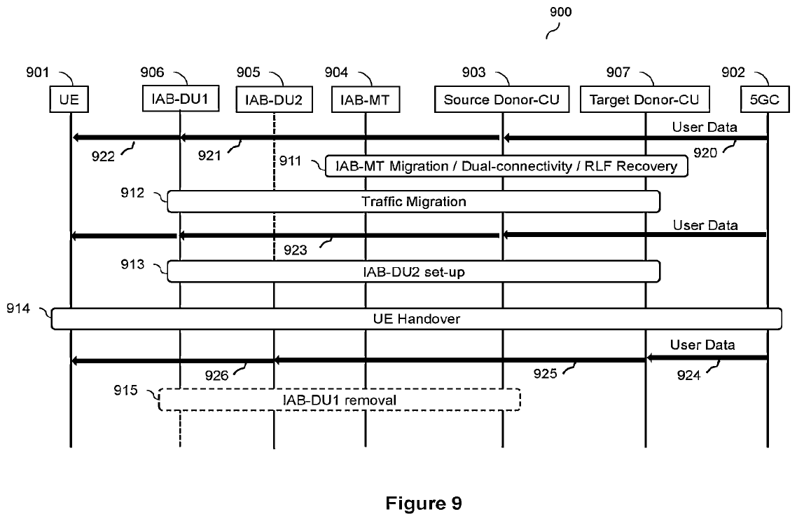

The full migration of the mobile IAB-node 670 is also the opportunity for the donor CU 602 to change the PCI values used by the mobile IAB-node 670 in case of potential conflicts. The procedure for PCI change associated to the full migration of a mobile IAB-node is described with the FIG. 9 (inter-CU PCI change) according to embodiments of the invention. At the full migration of the IAB-node 670, the served UEs, like UE 680, also migrate from the source donor CU 601 to the target donor CU 602. UEs migration may be performed through a procedure (described at the FIG. 9), which is based on the handover procedure described in TS 38.300 V17.0.0 section 9.2.3.2.

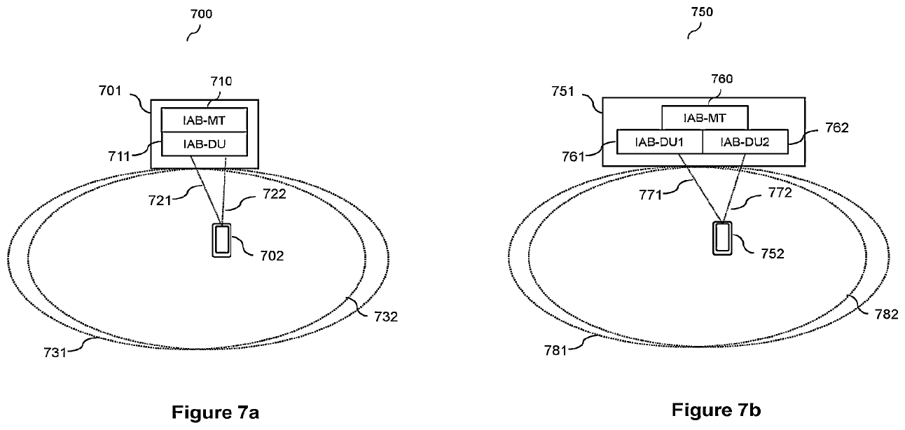

FIG. 7a illustrates an example of IAB-node architecture 700 enabling a smooth intra-CU PCI change without service interruption for the UEs served by an IAB-node. An Intra-CU PCI change procedure, as described with the FIG. 8, applies to an IAB-node that is not fully migrating toward a new IAB-donor-CU.

While the description of some examples of the present invention focuses on a PCI change for a mobile IAB-node, the present invention does not preclude applications of the intra-CU PCI change procedure for a stationary IAB-node. Thus, the IAB-node 701 may be a mobile IAB-node like the mobile IAB-node 470 (also 570, 670), or an IAB-node like the IAB-node 460 (also 560, 660). The IAB-node 701 comprises an IAB-MT part or unit 710 and an IAB-DU part or unit 711.

Before the PCI change, a UE 702 is for instance in the cell 731 and connected to a donor CU (not represented), through IAB-DU 711 with the access link 721. The IAB-DU 711 may control several other cells not represented in the figure. Upon detection that the PCI of the cell 731 may be in conflict with other PCIs in the vicinity of the cell 731, the donor CU may trigger the PCI change procedure described at the FIG. 8. In this procedure, a new cell 732 controlled by IAB-DU 711 is activated, on which the UE 702 may also connect to the donor CU through IAB-DU 711 and with the access link 722.

In one example, a cell in the vicinity of the cell 731 may correspond to a cell adjacent to the cell 731, and which covers a geographical area that may partly or completely overlap with the geographical area covered by the cell 731. In another example, a cell in the vicinity of the cell 731 may correspond to a cell not adjacent to the cell 731 but adjacent to a third cell that is also adjacent to the cell 731.

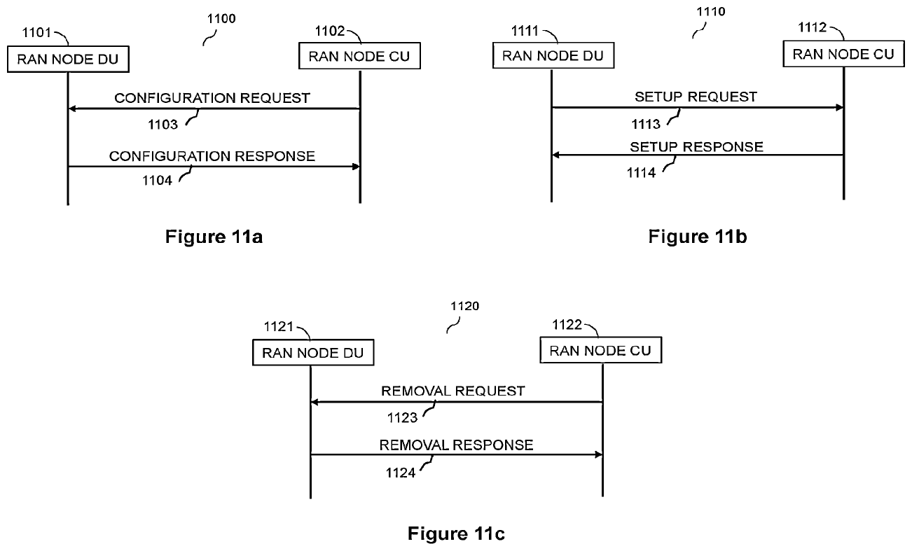

The activation of the cell 732 is triggered by the donor CU, for instance with the procedure described with reference to FIG. 11a. During the activation procedure, the donor CU indicates to the IAB-DU 711 the PCI value to be used for the cell 732.

Still referring to the procedure described at the FIG. 8, once the handover of UEs, like UE 702, is completed from the cell 731 to the cell 732, then the cell 732 may be deactivated.

The deactivation of a cell is triggered by the donor CU with the procedure described with reference to FIG. 11a, after the detection of the completion of UEs handover.

FIG. 7b illustrates another example of IAB-node architecture 750 enabling a smooth intra-CU PCI change or a smooth inter-CU PCI change without service interruption for the UEs served by an IAB-node. Intra-CU PCI change procedure, as described with reference to FIG. 8, applies to an IAB-node that is not fully migrating. Inter-CU PCI change procedure, as described with reference to FIG. 9, applies to an IAB-node that is fully migrating toward a different IAB-donor CU.

While a PCI change may be only necessary for a mobile IAB-node, the invention does not preclude applications of the intra-CU PCI change procedure and the inter-CU PCI change procedure for a stationary IAB-node. Thus, the IAB-node 751 may be a mobile IAB-node like the mobile IAB-node 470 (also 570, 670), or an IAB-node like the IAB-node 460 (also 560, 660). The IAB-node 751 comprises an IAB-MT part or unit 760, an IAB-DU1 part or unit 761, and an IAB-DU2 part or unit 762. Both IAB-DU1 and IAB-DU2 are logical DU entities that share the same hardware for the BAP, RLC, and MAC layers. In one embodiment, they share the same physical layer (i.e. the same hardware resources), while in another embodiment they rely on separated physical layers. In this example, IAB-DU1 761, when activated, controls the cell 781 and IAB-DU2 762, when activated, controls the cell 782. Both IAB-DU1 761 and IAB-DU2 762 may handle several other cells not represented in the figure.

Only one logical DU is sufficient for IAB operations, except at the intra-CU PCI change, at the inter-CU PCI change, or at the full migration without PCI change of the IAB-node 751, when both logical DUs are active. For intra-CU PCI change, both logical DUs terminates a F1 interface with a same donor CU. For inter-CU PCI change, one of the logical DU terminates the F1 interface with a source donor CU, while the other logical DU terminates the F1 interface with a target donor CU.

The architecture of the FIG. 7b may be used for intra-CU PCI change, in case the processing load of the logical DU IAB-DU1 761 is high because of a high number of cells. In this case, the processing load of IAB-DU1 761 may be alleviated by the activation of the second logical DU IAB-DU2 762 during the PCI change phase.

In case of intra-CU PCI change and before the operation, a UE 752 is for instance in the cell 781 and connected to a donor CU (not represented), through IAB-DU1 761 with the access link 771. Upon detection that the PCI of the cell 781 may be in conflict with other PCIs in the vicinity of the cell 781, the donor CU may trigger the PCI change procedure, where the logical DU IAB-DU2 762 is activated with the new cell 782, on which the UE 752 may also connect to the donor CU through the access link 772.

The activation of the logical DU IAB-DU2 762 with the cell 782 is triggered by the donor CU, for instance with the procedure described with the FIG. 11a. During the activation procedure, the donor CU indicates to the IAB-DU1 761 the PCI value to be used for the cell 782.

Referring to the procedure described at the FIG. 8, once the handover of UEs, like UE 752, from the cell 781 to the cell 782 is completed, then the cell 781 is deactivated.

The deactivation of the cell is triggered by the donor CU with the procedure described with the FIG. 11c, after the detection of the completion of UEs handover.

When activating the logical DU IAB-DU2 762, the donor CU may activate as many cells as the number of cells controlled by the logical DU IAB-DU1 761. Then, all the UEs connected through the logical DU IAB-DU1 are handed over via a cell controlled by the logical DU IAB-DU2 762. Once the handover of all UEs is completed, the donor CU deactivates the logical DU IAB-DU1 761, along with all the cells it was controlling. The deactivation of the logical DU IAB-DU1 761 is triggered by the donor CU, for instance with the procedure described with the FIG. 11c, after the detection of the completion of UEs handover.

In case of inter-CU PCI change and before the operation, a UE 752 is for instance in the cell 781 and connected to a source donor CU through the logical DU IAB-DU1 761 with the access link 771, while the logical DU IAB-DU2 762 is deactivated. During the PCI change procedure described with the FIG. 9, the logical DU IAB-DU2 762 is activated and connects to a target donor CU, on which the UE 752 may also connect to through the logical DU IAB-DU2 762 with the cell 782 and the access link 772.

The activation of the logical DU IAB-DU2 762 may be triggered by the IAB-node, then the setup is achieved with the procedure described with the FIG. 11b. The target donor CU may indicate the PCI value to be used for the cell(s), like the cell 782, to be activated with the second logical DU, for instance with the procedure described with the FIG. 11b.

Still referring to the procedure described at the FIG. 9, once the handover of UEs, like UE 752, from the cell 781 to the cell 782 is completed, then the cell 781 is deactivated

The deactivation of the cell is triggered by the source donor CU with the procedure described with the FIG. 11a, after the detection of the completion of UEs handover.

When activating the logical DU IAB-DU2 762, the target donor CU may activate as many cells as the number of cells controlled by the logical DU IAB-DU1 761. Then, all the UEs connected through the logical DU IAB-DU1 761 are handed over a cell controlled by the logical DU IAB-DU2 762. Once the handover of all UEs is completed, the source donor CU deactivates the logical DU IAB-DU1 761, along with all the cells it was controlling.

The deactivation of the logical DU IAB-DU1 761 is triggered by the source donor CU, for instance with the procedure described with the FIG. 11c, after the detection of the completion of UEs handover.

FIG. 8 is a simplified flowchart 800 illustrating an example of steps to perform the intra-CU PCI change procedure, in order to change the PCI of one or several cells controlled by an IAB-node without service interruption for the served UEs. It is based on the architecture of an IAB-node described in the FIG. 7a or 7b.

This figure shows a UE 801 like the UE 580, a donor CU 803 like the donor CU 501, the core network (5GC) 802 like the core network 110. This figure also shows an IAB-node like the IAB-node 701 of the FIG. 7a, composed of an IAB-MT part or unit 804 and an IAB-DU1 part or unit 805, or like the IAB-node 751 of the FIG. 7b, composed of an IAB-MT part or unit 804, an IAB-DU1 part or unit 805, and an IAB-DU2 part or unit 806. IAB-DU1 and IAB-DU2 are two logical DU entities that share the same hardware for the BAP, RLC, and MAC layers. In one embodiment, they share the same physical layer (i.e. the same hardware resources), while in another embodiment they rely on separated physical layers.

At the beginning of the flowchart, the UE 801 is served by the IAB-node through a cell controlled by IAB-DU1 805, while in case of the architecture of the FIG. 7b is used, the logical DU IAB-DU2 806 is inactive. The user data in the downstream direction are provided by the 5GC 802 to the donor CU 803 through the bearer 820, then they are transmitted to the logical DU IAB-DU1 805 through the backhaul bearer 821, and finally to the UE 801 through the data radio bearer 822. User data in the upstream direction (not represented in the figure) are transmitted through similar bearers in the opposite direction.

After the decision by the donor CU 803 to change the PCI value for one or several cells controlled by the IAB-node and having determined the new PCI value(s) to be used, the first step 811 corresponds to the activation of cell(s) using the new PCI value(s). The new cell(s) are controlled by the logical DU IAB-DU1 805 in case of the architecture of the FIG. 7a is used, or they are controlled by the logical DU IAB-DU2 806 in case of the architecture of the FIG. 7b is used. In this latter case, the step 811 includes the activation of the logical DU IAB-DU2. In all cases, there may be as many cells created as the number of PCI values to change, or as many cells as the number of cells controlled by the logical DU IAB-DU1 805. For instance, the procedure described with the FIG. 11a is used for the activation of the logical DU IAB-DU2 806 and for the activation of the cell(s).

The next step 812 consists in the handover of UEs served by the IAB node, from a cell controlled by the logical DU IAB-DU1 805 having a first PCI value, to a cell using a new, second, PCI value, controlled either by the logical DU IAB-DU1 805 (case of the architecture in FIG. 7a), or by the logical DU IAB-DU2 806 (case of the architecture in FIG. 7b). The UE handover procedure corresponds to the procedure described in TS 38.401 V17.0.0 section 8.2.1.2.

In case of an IAB-node using the architecture of the FIG. 7a, once the handover is completed for the UE 801, the user data in the downstream direction are transmitted by the core network 802 to the donor CU 803 through the bearer 820, then they are transmitted to the logical DU IAB-DU1 805 through the backhaul bearer 821, and finally to the UE 801 through the new data radio bearer 823 in the new cell. User data in the upstream direction (not represented in the figure) are transmitted through similar bearers in the opposite direction.

In case of an IAB-node using the architecture of the FIG. 7b, once the handover is completed for the UE 801, the user data in the downstream direction are transmitted by the core network 802 to the donor CU 803 through the bearer 820, then they are transmitted to the logical DU IAB-DU2 806 through the backhaul bearer 824, and finally to the UE 801 through the data radio bearer 825 in the new cell. User data in the upstream direction (not represented in the figure) are transmitted through similar bearers in the opposite direction.

At step 813, once the handover is completed for all UEs served in the cell with the first PCI, then the cell may be deactivated. The procedure described with the FIG. 11a may be used for the cell deactivation.

In case of an IAB-node using the architecture of the FIG. 7b, when the handover is completed for all UEs served by the logical DU IAB-DU1 805, then this logical DU may be deactivated. The procedure described with the FIG. 11c may be used. The deactivation of the cell(s) controlled by the logical DU IAB-DU1 805 may be performed at the same time.

FIG. 9 is a simplified flowchart 900 illustrating an example of steps to perform the inter-CU PCI change procedure, in order to change the PCI of one or several cells controlled by an IAB-node without service interruption for the served UEs. It is based on the architecture of an IAB-node described int the FIG. 7b. This procedure may be part of the full migration procedure for an IAB-node that may be a mobile IAB-node.

This figure shows a UE 901 like the UE 580, a source donor CU 903 like the donor CU 501, a target donor CU 907 like the donor CU 502, and the core network (5GC) 902 like the core network 110. This figure also shows an IAB-node, like the IAB-node 751, comprising an IAB-MT part or unit 904, an IAB-DU1 part or unit 905, and an IAB-DU2 part or unit 906. IAB-DU1 and IAB-DU2 are two logical DU entities that share the same hardware for the BAP, RLC, and MAC layers. In one embodiment, they share the same physical layer (i.e. the same hardware resources), while in another embodiment they rely on separated physical layers.

At the beginning of the flowchart, the UE 901 is served by the IAB-node through a cell controlled by IAB-DU1 905, while the logical DU IAB-DU2 806 is inactive. The user data in the downstream direction are provided by the 5GC 902 to the donor CU 903 through the bearer 920, then they are transmitted to the logical DU IAB-DU1 905 through the backhaul bearer 921, and finally to the UE 901 through the data radio bearer 922. User data in the upstream direction (not represented in the figure) are transmitted through similar bearers in the opposite direction

The first step 911 corresponds either to the partial migration of the IAB-node, or to the establishment of dual connectivity of the mobile IAB-node, or to the RLF recovery of the mobile IAB-node. After this step the IAB-node is a boundary node between the source IAB topology controlled by IAB donor CU 903 and the target IAB topology controlled by the target donor CU 907.

In case of partial migration, the IAB Inter-CU Topology Adaptation procedure described in TS 38.401 V17.0.0 section 8.17.3.1 may be applied, after which the IAB-node still belongs to the IAB topology controlled by the source donor CU 903, but has its RRC connection with the target donor CU 907.

In case of dual-connectivity setup, the topology redundancy procedure may be applied, as described in TS 38.401 V17.0.0 section 8.17.2.1, where a dual connectivity is established for the IAB-node with two parent IAB-nodes belonging to two different IAB topologies.

In case of RLF recovery, the inter-CU backhaul RLF recovery procedure may be applied, as described in TS 38.401 V17.0.0 section 8.17.4, which enables the recovery of an IAB-node to another parent node underneath a different IAB-donor-CU, when the IAB-MT of the IAB-node declares a backhaul RLF.

The step 912 corresponds to the traffic migration relying on the IAB transport migration management procedure specified in TS 38.423 V17.0.0 section 8.5.2. After this step, the user data in the downstream direction are still delivered to the UE 901 through the IAB-DU1 905, but through the backhaul bearer 923 in the target IAB topology controlled by the target donor CU 907. User data in the upstream direction (not represented in the figure) are transmitted through similar bearers in the opposite direction.

The step 913 corresponds to the activation of the second logical DU IAB-DU2 906 in the IAB node including the activation of one or several cells controlled by the IAB-DU2 906. The activation may be triggered in the IAB-node itself for instance after it gets a RRC connection with the target donor CU 907. The setup of the IAB-DU2 906 may be achieved using the procedure described in the FIG. 11b. The target donor CU 907 receiving a setup request from IAB-DU2 906, will respond with a request to create new cell(s) controlled by IAB-DU2 906. There may be as many cells created as the number of cells controlled by the logical DU IAB-DU1 905. Besides, the IAB-donor-CU 907 may detect that the PCI value used in one or several cells controlled by IAB-DU1 905 may be in conflict with the PCI value(s) in the vicinity. Thus, the IAB-donor-CU 907 will obtain new PCI value(s) to be used for the cell(s) to be controlled by IAB-DU2 906. In case of full migration of the mobile IAB-node, there will be as many cells created as the number of cells controlled by the logical DU IAB-DU1 905. The IAB-donor-CU 907 will obtain new PCI value(s) to be used for the cell(s) to be controlled by IAB-DU2 906. If the PCI value used in one or several cells controlled by IAB-DU1 905 is in conflict with the PCI value(s) in the vicinity, then the conflict will be resolved when the full migration is complete (at step 915).

To complete the step 913, the target donor CU 907 informs the source donor CU 903 about the activation of the second logical DU IAB-DU2 906 and of the cell(s) with the new PCI value(s), for instance with the procedure described in the FIG. 12a.

After activation of the second logical DU and new cell(s) in the IAB node (step 913), the next step 914 consists in the handover of UEs served by the IAB node, from a cell controlled by the first logical DU mIAB-DU1 905 to a cell controlled by the second logical DU IAB-DU2 906. The UE handover is based on the procedures described in TS 38.300 V17.0.0 section 9.2.3. The step 914 can be triggered by the source donor CU 903 after the notification of the activation of cell(s) in the second logical DU IAB-DU2 906, received at the end of the step 913. Alternately, it may be triggered when the source donor CU 903 receives a measurement report from the UE indicating that the UE receives radio signals in a cell controlled by the IAB-DU2 906.

Once the handover is completed for the UE 901, the user data in the downstream direction are transmitted by the core network 902 to the target donor CU 907 through the bearer 924, then they are transmitted to the logical DU IAB-DU2 906 through the backhaul bearer 925, and finally to the UE 901 through the data radio bearer 926 in the new cell. User data in the upstream direction (not represented in the figure) are transmitted through similar bearers in the opposite direction.

Once the handover is completed for all UEs served in a cell with a potentially conflicting PCI, then the cell may be deactivated. The procedure described with the FIG. 11c may be used for the cell deactivation.

When the handover is completed for all UEs served by the logical DU IAB-DU1 905, then this logical DU may be deactivated. The procedure described with the FIG. 11c may be used. The deactivation of the cell(s) controlled by the logical DU IAB-DU1 905 may be performed at the same time.

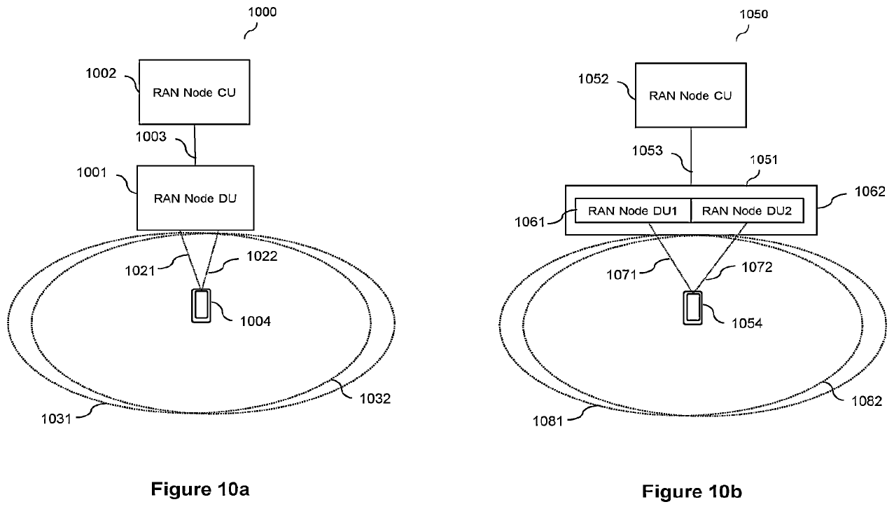

FIG. 10a illustrates an example of a base station or RAN (Radio Access Network) node architecture 1000 enabling a smooth intra-CU PCI change without service interruption for the UEs served by the RAN node. Indeed, the intra-CU PCI change procedure may also apply to a RAN node, like a gNB, that is not an IAB-node. For instance, PCI change may be required when the RAN node is moving, or at least when a DU part of the RAN node is moving. This may be the case in, for example, non-terrestrial networks where the DU part is embedded in a satellite or a drone.

This FIG. 10a shows a RAN node split into the CU part (RAN Node CU) 1002 and the DU part (RAN Node DU) 1001, connected with the link 1003 that may be a wired or a wireless link.

Before the PCI change, a UE 1004 is for instance in the cell 1031 and connected to the CU 1002, through the DU 1001 with the radio link 1021. The DU 1001 may control several other cells not represented in the figure. Upon detection by the CU 1002 that the PCI of the cell 1031 may be in conflict with other PCIs in the vicinity of the cell 1031, the CU 1002 may trigger the PCI change procedure, where a new cell 1032 controlled by the DU 1001 is activated, on which the UE 1004 may also connect to the CU 1002 through the DU 1001 and the radio link 1022.

The activation of the cell 1032 is triggered by the CU 1002, for instance with the procedure described with the FIG. 11a. During the activation procedure, the CU indicates to DU 1001 the PCI value to be used for the cell 1032.

Still referring to the procedure described at the FIG. 8, once the handover of all UEs, like UE 1004, is completed from the cell 1031 to the cell 1032, then the cell 1032 is deactivated.

The deactivation of a cell is triggered by the CU 1002 with the procedure described with the FIG. 11a, after the detection of the completion of UEs handover.

FIG. 10b illustrates another example of a base station or RAN node architecture 1050 enabling a smooth intra-CU PCI change, or inter-CU PCI change, without service interruption for the UEs served by the RAN node.

This FIG. 10b shows a RAN node split into the CU part (RAN Node CU) 1052 and the DU part 1051, connected with the link 1053 that may be a wired or a wireless link.

The DU part 1051 is composed of a first logical DU1 (RAN Node DU1) 1061, and a second logical DU2 (RAN Node DU2) 1062. Both DU1 and DU2 are logical DU entities that share the same hardware for the BAP, RLC, and MAC layers. In one embodiment, they share the same physical layer (i.e. the same hardware resources), while in another embodiment they rely on separated physical layers. In this example, DU1 1061, when activated, controls the cell 1081 and DU2 1062, when activated, controls the cell 1082. Both DU1 1061 and DU2 1062 may handle several other cells not represented in the figure.

Only one logical DU is sufficient for operations, except at the intra-CU PCI change or at the inter-CU PCI change, when both logical DUs are active. For intra-CU PCI change, both logical DUs terminates a F1 interface with a same CU 1052. For inter-CU PCI change, one of the logical DU terminates the F1 interface with the CU 1052, which can be referred to as the source CU, while the other logical DU terminates the F1 interface with a target CU not represented on the Figure.

Here, the inter-CU PCI change would apply when the source CU and the target CU are stationary entities, and only the DU entity 1051 is moving (e.g. embedded in a satellite or a drone).

In case of intra-CU PCI change and before the operation, a UE 1054 is for instance in the cell 1081 and connected to the CU 1052, through the DU1 1061 with the radio link 1071. The DU 1061 may control several other cells not represented in the figure. Upon detection by the CU 1052 that the PCI of the cell 1081 may be in conflict with other PCIs in the vicinity of the cell 1081, the CU 1052 may trigger the PCI change procedure, where the logical DU2 1062 is activated with the new cell 1082, on which the UE 1054 may also connect to the CU 1052 through the DU2 1062 and the radio link 1072.

The activation of the logical DU2 1062 with the cell 1082 is triggered by the CU 1052, for instance with the procedure described with the FIG. 11a. During the activation procedure, the CU 1052 indicates to the DU1 1061 the PCI value to be used for the cell 1082.

Once the handover of UEs, like UE 1054, from the cell 1081 to the cell 1082 is completed, then the cell 1081 is deactivated.

The deactivation of the cell is triggered by the CU 1052 with the procedure described with the FIG. 11a, after the detection of the completion of UEs handover.

When activating the logical DU2 1062, the CU 1052 may activate as many cells as the number of cells controlled by the logical DU1 1061. Then, all the UEs connected through the logical DU1 1061 are handed over a cell controlled by the logical DU2 1062. Once the handover of all UEs is completed, the CU 1052 deactivates the logical DU1 1061 with all the cells it was controlling.

The deactivation of the logical DU1 1061 is triggered by the CU 1052, for instance with the procedure described with the FIG. 11c, after the detection of the completion of UEs handover.

In case of inter-CU PCI change and before the operation, a UE 1052 is for instance in the cell 1081 and connected to the source CU 1052 through the logical DU1 1061 with the radio link 1071, while the logical DU2 1062 is deactivated. During the PCI change procedure, the logical DU2 1062 is activated and connects to a target CU, on which the UE 1054 may also connect to through the logical DU2 1062 with the cell 1082 and the radio link 1072.

The activation of the logical DU2 1062 is triggered by the source CU, for instance with the procedure described with the FIG. 11a. During the activation procedure, the target CU indicates (using the procedure of the FIG. 11b), the PCI value to be used for the cell(s), like the cell 1082, to be activated with the second logical DU.

Once the handover of UEs, like UE 1054, from the cell 1081 to the cell 1082 is completed, then the cell 1081 is deactivated.

The deactivation of the cell is triggered by the source CU 1052 with the procedure described with the FIG. 11c, after the detection of the completion of UEs handover.

When activating the logical DU2 1062, the target CU may activate as many cells as the number of cells controlled by the logical DU1 1061. Then, all the UEs connected through the logical DU1 1061 are handed over a cell controlled by the logical DU2 1062. Once the handover of all UEs is completed, the source CU 1052 deactivates the logical DU1 1061 with all the cells it was controlling.

The deactivation of the logical DU1 1061 is triggered by the source CU 1052, for instance with the procedure described with the FIG. 11c, after the detection of the completion of UEs handover.

FIG. 11a is a flowchart 1100 illustrating an example of the procedure to perform the activation of a logical DU and/or cell(s) according to embodiments of the invention. It is also used to deactivate cell(s).

This figure shows:
a RAN Node DU 1101, like the RAN Node DU 1001 or 1061, that may be a gNB-DU, or an IAB-Node DU like IAB-DU 711 or 761.
a RAN Node CU 1102, like the RAN Node CU 1002 or 1052, that may be a gNB-CU, or an IAB-Donor CU like IAB-donor CU 601 or 602.

The message CONFIGURATION REQUEST 1103 is sent by the RAN Node CU 1102 to the RAN Node DU 1101 either to request the activation of new cell(s) controlled by the RAN Node DU 1101, or to request the activation of a second logical DU, or to request the deactivation of cell(s) controlled by the RAN Node DU 1101.

The RAN Node DU 1101 acknowledges the request with the message CONFIGURATION RESPONSE 1104 sent to the RAN Node CU 1102.

According to one embodiment of the invention, the FIG. 11a corresponds to the procedure gNB-CU Configuration Update described in TS 38.473 V17.0.0 section 8.2.5, and the message 1103 corresponds to the message GNB-CU CONFIGURATION UPDATE described in TS 38.473 V17.0.0 section 9.2.1.10, while the message 1104 corresponds to the message GNB-CU CONFIGURATION UPDATE ACKNOWLEDGE described in TS 38.473 V17.0.0 section 9.2.1.11.

The message GNB-CU CONFIGURATION UPDATE includes the Information Element (IE) Cells to be Activated List to indicate the list of new cell(s) to be activated with the PCI value(s) to be used. The cell(s) to be activated refer to cell(s) controlled by the RAN Node DU 1101 receiving the request.

The message GNB-CU CONFIGURATION UPDATE also includes the Information Element (IE) Cells to be Deactivated List to indicate the list cell(s) to be deactivated. The cell(s) to be deactivated refer to cell(s) controlled by the RAN Node DU 1101 receiving the request.

According to one embodiment of the invention, a new IE Second DU Activation may be added in the message 1103 in the form of a Boolean to request the activation of a second logical DU.

To complete the setup of the new logical DU, the procedure described with the FIG. 11b may be used.

FIG. 11b is a flowchart 1110 illustrating an example of the procedure to setup a logical DU.

This figure shows:
a RAN Node DU 1111, like the RAN Node DU 1001 or 1061, that may be a gNB-DU, or an IAB-Node DU like IAB-DU 711 or 761.
a RAN Node CU 1112, like the RAN Node CU 1002 or 1052, that may be a gNB-CU, or an IAB-Donor CU like IAB-donor CU 601 or 602.

The message SETUP REQUEST 1113 is sent by the RAN Node DU 1101 to the RAN Node CU 1102 to request the F1 setup for the logical DU. It may be sent after an activation request as described in the FIG. 11a.

The RAN Node CU 1112 answers with the message SETUP RESPONSE 1114 sent to the RAN Node DU 1111.

According to one embodiment of the invention, the FIG. 11b corresponds to the procedure F1 setup described in TS 38.473 V17.0.0 section 8.2.3, and the message 1113 corresponds to the message F1 SETUP REQUEST described in TS 38.473 V17.0.0 section 9.2.1.4, while the message 1114 corresponds to the message F1 SETUP RESPONSE described in TS 38.473 V17.0.0 section 9.2.1.5. The message F1 SETUP RESPONSE includes the Information Element (IE) Cells to be Activated List to indicate the list of new cell(s) to be activated with the PCI value(s) to be used. The cell(s) to be activated refer to cell(s) controlled by the RAN Node DU 1111 receiving the response.

FIG. 11c is a flowchart 1120 illustrating an example of the procedure to remove a logical DU.

This figure shows:
a RAN Node DU 1121, like the RAN Node DU 1001 or 1061, that may be a gNB-DU, or an IAB-Node DU like IAB-DU 711 or 761.
a RAN Node CU 1122, like the RAN Node CU 1002 or 1052, that may be a gNB-CU, or an IAB-Donor CU like IAB-donor CU 601 or 602.

The message REMOVAL REQUEST 1123 is sent by the RAN Node CU 1122 to the RAN Node DU 1121 to request the removal of the logical DU.

The RAN Node DU 1121 answers with the message REMOVAL RESPONSE 1114 sent to the RAN Node CU 1122.

According to one embodiment of the invention, the FIG. 11c corresponds to the procedure F1 removal described in TS 38.473 V17.0.0 section 8.2.8, and the message 1123 corresponds to the message F1 REMOVAL REQUEST described in TS 38.473 V17.0.0 section 9.2.1.16, while the message 1114 corresponds to the message F1 REMOVAL RESPONSE described in TS 38.473 V17.0.0 section 9.2.1.7.

FIG. 12a is a flowchart 1200 illustrating an example of the procedure used by a RAN Node CU to report new usage of PCI value(s) to another RAN Node CU.

This figure shows two RAN Node CUs, RAN Node CUa 1201 and RAN Node CUb 1202, like the RAN Node CU 1002 or 1052, that may be a gNB-CU, or an IAB-donor CU like IAB-donor CU 601 or 602.

The message CONFIGURATION UPDATE 1203 is sent by the RAN Node CUa 1201 to the RAN Node CUb 1202 to indicate new PCI(s) usage in cell(s) managed by the RAN Node CUa 1201.

According to one embodiment of the invention, the message 1203 corresponds to the message NG-RAN NODE CONFIGURATION UPDATE described in TS 38.423 V17.0.0 section 9.1.3.4, which may include a new IE Cells Activated List to indicate the list of new cell(s) with the PCI(s) used, and another new IE Cells Deactivated List to indicate the list of removed cell(s) with the PCI(s) no more used.

FIG. 12b is a flowchart 1210 illustrating an example of the procedure used by a RAN Node CU to report new usage of PCI value(s) to the core network.

This figure shows:
a RAN Node CU 1211, like the RAN Node CU 1002 or 1052, that may be a gNB-CU, or an IAB-donor CU like IAB-donor CU 601 or 602,
the core network (5GC) 1212, like the core network 110.

The message CONFIGURATION UPDATE 1213 is sent by the RAN Node CU 1211 to the core network 1212 to indicate new PCI(s) usage in cell(s) managed by the RAN Node CU 1211.

According to one embodiment of the invention, the message 1213 corresponds to the message UPLINK RAN CONFIGURATION TRANSFER described in TS 38.413 V17.0.0 section 9.2.7.1, which may include a new IE Cells Activated List to indicate the list of new cell(s) with the PCI(s) used, and another new IE Cells Deactivated List to indicate the list of removed cell(s) with the PCI(s) no more used.

According to another embodiment of the invention, the message 1213 includes a new IE to indicate the location of a cell, for instance with a list of neighbor cells for a dedicated cell. For instance, this new IE Neighbor Cells List is used to report the new list of neighbor cells for a cell controlled by a mobile IAB node, or a mobile RAN Node DU, when it has moved.

FIG. 12c is a flowchart 1220 illustrating an example of the procedure used by the core network to indicate a list of PCI value(s) that can be used by a RAN Node CU.

This figure shows:
a RAN Node CU 1221, like the RAN Node CU 1002 or 1052, that may be a gNB-CU, or an IAB-donor CU like IAB-donor CU 601 or 602,
the core network (5GC) 1222, like the core network 110.

The message CONFIGURATION UPDATE 1213 is sent by the core network 1222 to the RAN Node CU 1221 to indicate new PCI(s) to be used in cell(s) managed by the RAN Node CU 1221.

According to one embodiment of the invention, the message 1223 corresponds to the message DOWNLINK RAN CONFIGURATION TRANSFER described in TS 38.413 V17.0.0 section 9.2.7.2, which may include a new IE PCIs List to indicate the list of PCIs that can be used.

According to one embodiment of the invention, the message 1223 includes a new IE Cells List, containing a list of cells, and for each cell an IE PCIs List indicates a list of PCIs that can be used for this cell.

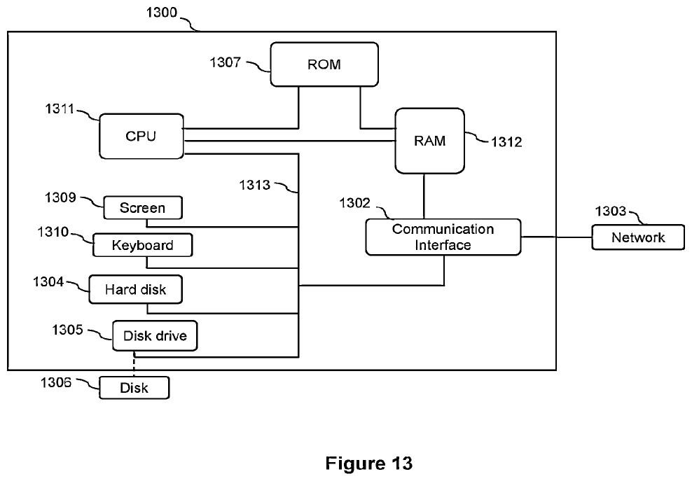

FIG. 13 shows a schematic representation of an example communication device (apparatus) or station, in accordance with one or more example embodiments of the present disclosure.

The communication device 1300 may preferably be a device such as a micro-computer, a workstation or a light portable device. The communication device 1300 comprises a communication bus 1113 to which there are preferably connected:
a central processing unit 1311, such as a microprocessor, denoted CPU;
memory for storing data and computer programs containing instructions for the operation of the communication device 1300. The computer programs may contain a number of different program elements (modules) or sub-routines containing instructions for a variety of operations and for implementing the invention. For example, the program elements include an element to implement a BAP entity which as discussed above is for routing data packets to a node in the IAB topology; and
at least one communication interface 1302 for communicating with other devices or nodes in a wireless communication system, such as a wireless communication system 100 according to the release 16 for 5G NR. The at least one communication interface 1302 may be connected to a communication network 1303, such as a radio access network of the system 100, over which digital data packets or frames or control frames are transmitted. The frames are written from a FIFO sending memory in RAM 1312 to the communication interface for transmission or are read from the communication interface for reception and writing into a FIFO receiving memory in RAM 1312 under the control of a software application running in the CPU 1311.

Each of a donor CU, a donor DU and an IAB node may comprise such a communication device 1100.

The central processing unit 1311 may be a single processing unit or processor or may comprise two or more processing units or processors carrying out the processing required for the operation of the communication device 1300. The number of processors and the allocation of processing functions to the central processing unit 1311 is a matter of design choice for a skilled person.

The memory may include:
a read only memory 1307, denoted ROM, for storing computer programs for implementing the invention;
a random-access memory 1312, denoted RAM, for storing the executable code of methods according to one or more embodiments of the invention as well as the registers adapted to record variables and parameters necessary for implementing methods according to one or more embodiments of the invention.

Optionally, the communication device 1300 may also include the following components:
a data storage means 1304 such as a hard disk, for storing computer programs for implementing methods according to one or more embodiments of the invention;
a disk drive 1305 for a disk 1306, the disk drive being adapted to read data from the disk 1306 or to write data onto said disk;
a screen 1309 for displaying decoded data and/or serving as a graphical interface with the user, by means of a keyboard 1310 or any other pointing means.

Preferably the communication bus provides communication and interoperability between the various elements included in the communication device 1300 or connected to it. The representation of the bus is not limiting and in particular, the central processing unit is operable to communicate instructions to any element of the communication device 1300 directly or by means of another element of the communication device 1300.

The disk 1306 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to embodiments of the invention to be implemented.

The executable code may optionally be stored either in read only memory 1307, on the hard disk 1304 or on a removable digital medium such as for example a disk 1306 as described previously. According to an optional variant, the executable code of the programs can be received by means of the communication network 1303, via the interface 1302, in order to be stored in one of the storage means of the communication device 1300, such as the hard disk 1304, before being executed.

The central processing unit 1311 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 1304 or in the read only memory 1307, are transferred into the random-access memory 1312, which then contains the executable code of the program or programs, as well as registers for storing the variables and parameters necessary for implementing the invention.

In a preferred embodiment, the apparatus is a programmable apparatus which uses software to implement the invention. However, alternatively, the present invention may be implemented in hardware (for example, in the form of an Application Specific Integrated Circuit or ASIC). In an example implementation, the communication device (apparatus) is a programmable device/apparatus which uses software to implement the invention. Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “central processing unit” as used herein may refer to any of the foregoing structure or any other structure suitable for implementation of the techniques described herein. However, alternatively, the present invention may be implemented in hardware (for example, in the form of an Application Specific Integrated Circuit or ASIC or other logic element).

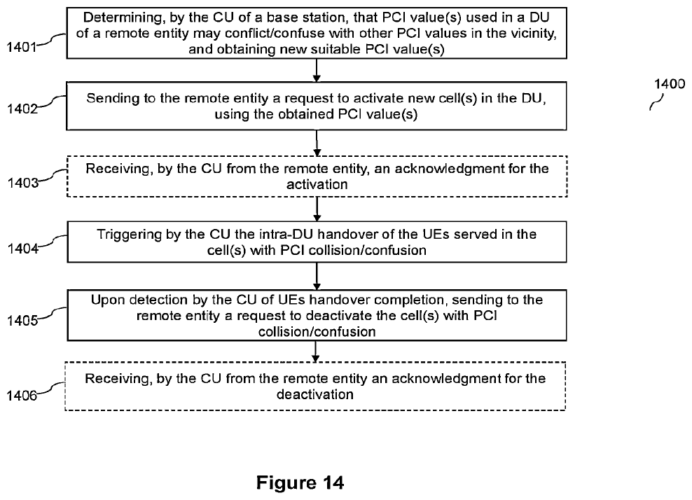

FIG. 14 illustrates, using a flowchart 1400, an example method according to embodiments and examples of the invention for managing at a CU of base station the change of PCI in one or several cells.

At step 1401, the CU determines that PCI value(s) used by a DU of a remote entity for a cell (or cells) may conflict/confuse with other PCI values in the vicinity of the cell(s), and obtains new suitable PCI value(s). For instance, the CU may report the location of the DU through the procedure described in the FIG. 12b and may receive the PCI value(s) to use with the procedure described in the FIG. 12c.

At step 1402, the CU sends to the remote entity a request to activate new cell(s) in the DU, using the obtained PCI value(s).

At step 1403, the CU may receive from the remote entity, an acknowledgment for the activation. This step is optional.

At step 1404, the CU triggers the intra-DU handover of the UEs served in the cell(s) with PCI collision/confusion.

At step 1405, upon detection by the CU of UEs handover completion, the CU sends to the remote entity a request to deactivate the cell(s) with PCI collision/confusion.

At step 1406, the CU may receive from the remote entity an acknowledgment for the deactivation of cell(s). This step is optional.

As an alternative method, the remote entity is the DU itself.

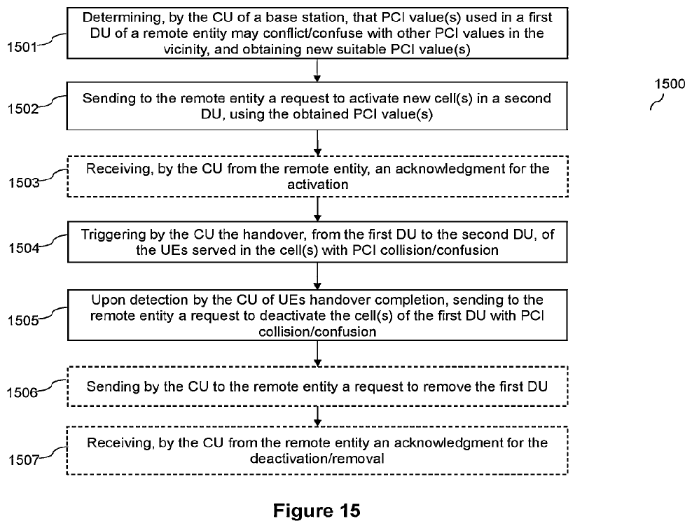

FIG. 15 illustrates, using a flowchart 1500, another example method according to embodiments and examples of the invention for managing at a CU of base station the change of PCI in one or several cells.

At step 1501, the CU determines that PCI value(s) used by a first DU of a remote entity for a cell (or cells) may conflict/confuse with other PCI values in the vicinity of the cell(s), and obtains new suitable PCI value(s).

At step 1502, the CU sends to the remote entity a request to activate new cell(s) in a second DU, using the obtained PCI value(s). This step may include the activation of the second DU if it was not yet activated.

At step 1503, the CU may receive from the remote entity, an acknowledgment for the activation. This step is optional.

At step 1504, the CU triggers the handover from the first DU to the second DU of the UEs served in the cell(s) with PCI collision/confusion. As an alternative step, the CU triggers the handover for all the UEs served by the first DU.

At step 1505, upon detection by the CU of UEs handover completion, the CU sends to the remote entity a request to deactivate the cell(s) of the first DU with PCI collision/confusion.

At step 1506, the CU sends to the remote entity a request to remove the first DU. This step is optional. As an alternative method, the step 1505 is skipped, and the step 1506 involves the automatic deactivation of cell(s) controlled by the first DU.

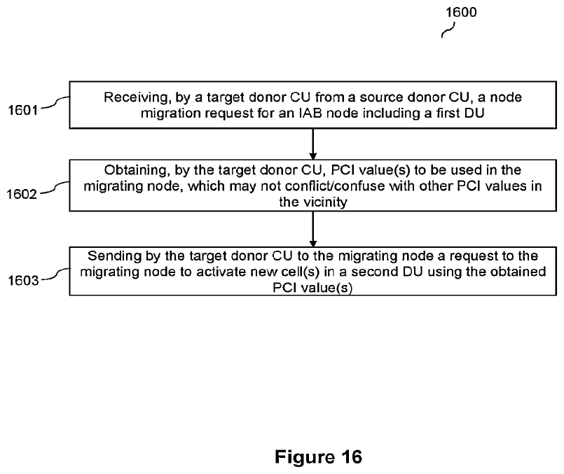

At step 1507, the CU may receive from the remote entity an acknowledgment for the deactivation of cell(s) and/or for the removal of the first DU. This step is optional. FIG. 16 illustrates, using a flowchart 1600, an example method according to embodiments and examples of the invention for managing at a target donor CU the migration of an IAB node including the change of PCI in one or several cells.

At step 1601, a target donor CU receives from a source donor CU, a node migration request for the IAB node including a first DU.

At step 1602, the target donor CU obtains PCI value(s) to be used by a second DU of the migrating node for a cell (or cells), which may not conflict/confuse with other PCI values in the vicinity.

At step 1603, the target donor CU sends a request to the migrating node to activate new cell(s) in a second DU using the obtained PCI value(s).

Then the steps 1504 to 1507 of the FIG. 15 may be applied.

About PCI partitioning limitations, it is admitted that PCI collision avoidance by OAM and PCI partitioning is not sufficient for some mobile IAB scenarios. First, the trajectory of a mobile IAB node may not always be predictable as it depends on the type of vehicle (e.g. taxi) or on the situation (e.g. temporary deployment). Thus, dedicating some specific PCI values for mobile IAB nodes would involve preventing the usage of these PCI values for any other RAN cells. This would put a high constraint to the stationary RAN cells because of the reduced PCI space available. As a consequence, the deployment of mobile IAB nodes may be restrained. To avoid adding such a too high constraint, the number of PCI values dedicated to mobile IAB nodes may be limited to a few values. Unless, the number of mobile IAB nodes in a same geographical area is limited to this number of dedicated PCI values, it cannot be avoided PCI collision or confusion situations with two mobile IAB nodes being close to each other, and using the same PCI values.

Besides, PCI planning should not only avoid PCI collision or confusion with the same PCI value used for two neighbouring cells (directly adjacent or adjacent to a common cell), but it may also minimize the cases of signal interferences that impacts the network performance, e.g. cases with same PCI mod 3 result (same PSS detected), cases with same PCI mode 4 Result (DMRS interference). Such a PCI planning optimization will not be feasible in case of mobile cells, even in case of PCI partitioning with dedicated values.

The consequence is that there is a need to be able to change the PCI value of one or several cell(s) of a mobile IAB node. This does not preclude PCI partitioning with dedicated PCI values for mobile IAB nodes. The advantage of PCI partitioning would be to decrease the number of cases where a PCI change is necessary while the mobile IAB node is moving.

Thus, PCI collision avoidance via dynamic PCI change shall be considered regardless a PCI partitioning is applied.

Additionally, it would be beneficial to avoid service interruption for the UEs served by a mobile IAB node when the PCI value of the serving cell is dynamically changed.

Thus, dynamic PCI change without service interruption for the served UEs shall be considered and may be referred to as smooth PCI change.

Two procedures may be considered for smooth PCI change:

1) The inter-donor-CU PCI change procedure where the PCI value is modified at a mobile IAB-DU and that applies when the mobile IAB node during the full migration toward a new IAB-donor-CU.

2) The intra-donor-CU PCI change procedure where the PCI value is modified at a mobile IAB-DU and that applies when the mobile IAB node is not fully migrating toward a new IAB-donor-CU.

Considering the first procedure (inter-donor-CU PCI change), the full migration of a mobile IAB-node is indeed the opportunity to change the PCI value(s) used by the mobile IAB-node in case of a potential conflict is detected. A smooth PCI change can be achieved by relying on the architecture enabling two logical DUs at the mobile IAB node. Then, when the second logical DU (under the target donor CU) is activated in the mobile IAB node, the activated cell(s) may use new PCI value(s) different from the PCI value(s) used for the cell(s) controlled by the first logical DU (under the source donor CU). At the full migration of the mobile IAB node, the served UEs, also migrate from the source donor CU to the target donor CU. A UE served by the first logical DU will be handed over through the legacy handover procedure (described in TS 38.300 V17.0.0 section 9.2.3.2), from a cell controlled by the first logical DU to a cell controlled by the second logical DU. Once the handover is completed for all UEs served by the first logical DU, then this first logical DU can be deactivated.

Considering the second procedure (intra-donor-CU PCI change), a smooth PCI change can be achieved by activating a new cell in the mobile IAB-DU with a new PCI value. A UE served by a cell with potential PCI conflict, will be handed over to the new cell with the new PCI value through the legacy handover procedure (described in TS 38.300 V17.0.0 section 9.2.3.2). Once the handover is completed for all UEs served in the cell with potential PCI conflict, then this cell can be deactivated.

Thus, in one aspect of the invention, two procedures may be considered for smooth PCI change:
1) the inter-donor-CU PCI change procedure when the mobile IAB node is fully migrating toward a new IAB-donor-CU, and
2) the intra-donor-CU PCI change when the mobile IAB node is not fully migrating toward a new IAB-donor-CU.

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1. A Physical Cell Identity, PCI, conflict avoidance method in a wireless network comprising a first base station controlling a first cell, the first cell having a first PCI, the procedure comprising:
determining a conflict between the first PCI and a PCI of another cell in the vicinity of the first cell; and
activating a second cell having a second PCI, wherein the second PCI is different to the first PCI.

2. A method according to claim 1, wherein the step of determining a conflict between the first PCI and the PCI of another cell in the vicinity of the first cell is performed by the first base station, or by a second base station of the wireless network, or by a core network controlling the wireless network.

3. (canceled)

4. (canceled)

5. A method according to claim 1, further comprising the step of determining a value of the second PCI.

6. A method according to claim 5, wherein the step of determining a value of the second PCI is performed by the first base station, or by a second base station of the wireless network, or by a core network controlling the wireless network.

7. (canceled)

8. A method according to claim 6 or 7, wherein the step of determining a value of the second PCI is performed by a Central Unit, CU, of the base station.

9. (canceled)

10. A method according to claim 1, wherein the step of activating the second cell is performed by a Distributed Unit, DU, of the first base station controlling the first cell, optionally wherein the step of activating the second cell is performed in response to a request of a Central Unit, CU, of the first base station.

11. (canceled)

12. A method according to claim 1, wherein the first cell is controlled by a first Distributed Unit, DU, of the first base station, and the step of activating the second cell is performed by a second DU of the first base station, optionally wherein the step of activating the second cell is performed in response to a request of the CU of the first base station.

13. (canceled)

14. A method according to claim 10, wherein the wireless network serves a user equipment initially connected to the first base station via a radio link in the first cell, the method further comprising the step of:
following activation of the second cell,
connecting the user equipment to the first base station via a radio link in the second cell.

15. A method according to claim 1, wherein the first cell is controlled by a Distributed Unit, DU, of the first base station, and the step of activating the second cell is performed by a DU of a second base station.

16. A method according to claim 15, wherein the step of activating the second cell is performed in response to a request of a CU of the second base station.

17. A method according to claim 15, wherein the wireless network serves a user equipment initially connected to the first base station via a radio link in the first cell, the method further comprising the step of:
following activation of the second cell,
connecting the user equipment to a second base station via a radio link in the second cell.

18. A method according to claim 12, wherein the first or second distributed unit is a logical distributed unit entity.

19. A method according to claim 12, wherein the first and second distributed units are both logical distributed unit entities sharing the same physical layer, or having separated physical layers.

20. (canceled)

21. A method according to claim 1, wherein the first base station is a Next Generation Radio Access Network node, or a CU of an Integrated Access and Backhaul, IAB, donor node.

22. (canceled)

23. A method according to claim 10, wherein the first base station is a CU of an Integrated Access and Backhaul, IAB, donor node, and the, or each, DU is the DU of an IAB node of the IAB topology controlled by the donor CU, optionally wherein the IAB node is a mobile IAB-node.

24. (canceled)

25. A method according to claim 1, further comprising the step of deactivating the first cell.

26. A method according to claim 10, further comprising the step of deactivating the first DU.

27. (canceled)

28. A method for a Central Unit, CU, of an Integrated Access and Backhaul, IAB, donor node, the CU of the IAB donor node controlling an IAB topology comprising a first cell established by a first Distributed Unit, DU, of an IAB node of the IAB topology, the method comprising:
determining a conflict between a Physical Cell Identity, PCI, of the first cell and a PCI of another cell in the vicinity of the first cell;
obtaining a new PCI that does not cause a conflict with the PCI of another cell in the vicinity of the first cell; and
instructing the IAB node to activate, by the first DU of the IAB node, a second cell having the new PCI.

29-30. (canceled)

31. A method for a Central Unit, CU, of an Integrated Access and Backhaul, IAB, donor node, the CU of the IAB donor node controlling an IAB topology comprising a first cell established by a first Distributed Unit, DU, of an IAB node of the IAB topology, the method comprising:
determining a conflict between a Physical Cell Identity, PCI, of the first cell and a PCI of another cell in the vicinity of the first cell;
obtaining a new PCI that does not cause a conflict with the PCI of another cell in the vicinity of the first cell; and
instructing the IAB node to activate, by a second DU of the IAB node, a second cell having the new PCI.

32-46. (canceled)

47. A non-transitory computer readable medium comprising instructions which, when executed by a computer, cause the computer to carry out the method according to claim 1.

48. (canceled)
